(19) United States
(12) Patent Application Publication
(10) Pub. No.: US 2026/0333340 A1
(43) Pub. Date: Oct. 22, 2026

(54) MULTI-USER CONTENT DIVERSITY

(71) Applicant: QUALCOMM Incorporated, San Diego, CA (US)

(72) Inventors: Hemanth SAMPATH, San Diego, CA (US); Belal Salama Amin KORANY, San Diego, CA (US); Hyun Yong LEE, San Diego, CA (US); Peerapol TINNAKORNSRISUPHAP, San Diego, CA (US); Prashanth Haridas HANDE, San Diego, CA (US)

(21) Appl. No.: 19/464,831

(22) Filed: Jan. 30, 2026

Related U.S. Application Data
(60) Provisional application No. 63/792,113, filed on Apr. 21, 2025.

(51) Int. Cl. H04W 72/12; H04W 72/51; H04W 72/543; H04W 72/563

(52) U.S. Cl. CPC H04W 72/12; H04W 72/51; H04W 72/543; H04W 72/563

(57) ABSTRACT

Various aspects generally relate to allocating resources or scheduling user equipments (UEs) in a wireless network according to content quality feedback. For example, before establishing an application session, a UE may indicate one or more values that the application supports for one or more metrics that impact or reflect content quality. The network node may leverage the application capability information in scheduling configurations or resource allocations. Furthermore, during an application session, the application may estimate a historical, current, or future content quality experienced by the application, which the UE may signal to the network node as content quality feedback. Accordingly, the network node may use content quality feedback signaled by different UEs to adapt scheduling configurations or resource allocations for different UEs or application sessions. For example, the network node may prioritize application content experiencing poor content quality over application content experiencing content quality that exceeds demands.

### CROSS-REFERENCE TO RELATED APPLICATION

This Patent Application claims priority to U.S. Provisional Patent Application No. 63/792,113, filed on Apr. 21, 2025, entitled “MULTI-USER CONTENT DIVERSITY,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with multi-user content diversity.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

For various reasons, a wireless network may implement various techniques to efficiently allocate resources among different user equipment (UE) devices to improve performance, capacity, fairness, and quality of service (QoS), among other examples. For example, wireless networks generally operate within a limited frequency spectrum, and may allocate bandwidth among UEs competing for access to avoid congestion and interference. In addition, different applications (for example, video streaming, voice calls, web browsing, or online gaming) have different QoS constraints, such as latency, throughput, or reliability constraints, such that wireless networks allocate time, frequency, spatial, or other resources to satisfy the diverse QoS constraints. Furthermore, dynamic resource allocation helps to adapt to UE movement and changing channel conditions (for example, changes to signal strength or interference), reduce energy consumption by avoiding unnecessary transmissions or other activities and placing UEs in low-power states when possible, ensure that all UEs are allocated a fair share of network resources to prevent scenarios where some UEs monopolize bandwidth while others receive poor service, or reduce interference in dense environments by scheduling communication with different UEs on different frequency resources, at different times, or different spatial directions, among other examples.

### SUMMARY

The systems, methods, and devices of this disclosure each have several innovative aspects, no single one of which is solely responsible for the desirable attributes disclosed herein.

Some aspects described herein relate to a UE. The UE may include a processing system. The processing system may include one or more processors and one or more code-storing memories coupled with the one or more processors. The processing system may be configured to cause the UE to communicate with a network node in accordance with a scheduling configuration, wherein communicating with the network node includes one or more of transmitting or receiving traffic related to content for one or more applications. The processing system may be configured to cause the UE to transmit, to the network node, content quality feedback indicating one or more of an estimated content quality or a target content quality related to at least one quality metric for the one or more applications.

Some aspects described herein relate to a network node. The network node may include a processing system. The processing system may include one or more processors and one or more code-storing memories coupled with the one or more processors. The processing system may be configured to cause the network node to communicate with a UE in accordance with a scheduling configuration, wherein communicating with the UE includes one or more of transmitting or receiving traffic related to content for one or more applications. The processing system may be configured to cause the network node to receive, from the UE, content quality feedback indicating one or more of an estimated content quality or a target content quality related to at least one quality metric for the one or more applications. The processing system may be configured to cause the network node to update the scheduling configuration in accordance with the content quality feedback.

Some aspects described herein relate to a network node. The network node may include a processing system. The processing system may include one or more processors and one or more code-storing memories coupled with the one or more processors. The processing system may be configured to cause the network node to receive, from a plurality of UEs, content quality feedback indicating one or more of estimated content qualities or target content qualities related to at least one quality metric for the plurality of UEs. The processing system may be configured to cause the network node to allocate resources for the plurality of UEs in accordance with the content quality feedback received from the plurality of UEs. The processing system may be configured to cause the network node to transmit, to each respective UE of the plurality of UEs, information related to the resources allocated to the respective UE.

Some aspects described herein relate to an application server. The application server may include a processing system. The processing system may include one or more processors and one or more code-storing memories coupled with the one or more processors. The processing system may be configured to cause the application server to receive, from a UE, content quality feedback indicating one or more of an estimated content quality or a target content quality related to at least one quality metric for one or more applications running at the UE. The processing system may be configured to cause the application server to communicate with the UE using a resource allocation for the one or more applications running at the UE in accordance with the content quality feedback received from the UE.

Some aspects described herein relate to a method of wireless communication performed by a UE. The method may include communicating with a network node in accordance with a scheduling configuration, wherein communicating with the network node includes one or more of transmitting or receiving traffic related to content for one or more applications. The method may include transmitting, to the network node, content quality feedback indicating one or more of an estimated content quality or a target content quality related to at least one quality metric for the one or more applications.

Some aspects described herein relate to a method of wireless communication performed by a network node. The method may include communicating with a UE in accordance with a scheduling configuration, wherein communicating with the UE includes one or more of transmitting or receiving traffic related to content for one or more applications. The method may include receiving, from the UE, content quality feedback indicating one or more of an estimated content quality or a target content quality related to at least one quality metric for the one or more applications. The method may include updating the scheduling configuration in accordance with the content quality feedback.

Some aspects described herein relate to a method of wireless communication performed by a network node. The method may include receiving, from a plurality of UEs, content quality feedback indicating one or more of estimated content qualities or target content qualities related to at least one quality metric for the plurality of UEs. The method may include allocating resources for the plurality of UEs in accordance with the content quality feedback received from the plurality of UEs. The method may include transmitting, to each respective UE of the plurality of UEs, information related to the resources allocated to the respective UE.

Some aspects described herein relate to a method of communication performed by an application server. The method may include receiving, from a UE, content quality feedback indicating one or more of an estimated content quality or a target content quality related to at least one quality metric for one or more applications running at the UE. The method may include communicating with the UE using a resource allocation for the one or more applications running at the UE in accordance with the content quality feedback received from the UE.

Some aspects described herein relate to a non-transitory computer-readable medium that stores a set of instructions for wireless communication by a UE. The set of instructions, when executed by one or more processors of the UE, may cause the UE to communicate with a network node in accordance with a scheduling configuration, wherein communicating with the network node includes one or more of transmitting or receiving traffic related to content for one or more applications. The set of instructions, when executed by one or more processors of the UE, may cause the UE to transmit, to the network node, content quality feedback indicating one or more of an estimated content quality or a target content quality related to at least one quality metric for the one or more applications.

Some aspects described herein relate to a non-transitory computer-readable medium that stores a set of instructions for wireless communication by a network node. The set of instructions, when executed by one or more processors of the network node, may cause the network node to communicate with a UE in accordance with a scheduling configuration, wherein communicating with the UE includes one or more of transmitting or receiving traffic related to content for one or more applications. The set of instructions, when executed by one or more processors of the network node, may cause the network node to receive, from the UE, content quality feedback indicating one or more of an estimated content quality or a target content quality related to at least one quality metric for the one or more applications. The set of instructions, when executed by one or more processors of the network node, may cause the network node to update the scheduling configuration in accordance with the content quality feedback.

Some aspects described herein relate to a non-transitory computer-readable medium that stores a set of instructions for wireless communication by a network node. The set of instructions, when executed by one or more processors of the network node, may cause the network node to receive, from a plurality of UEs, content quality feedback indicating one or more of estimated content qualities or target content qualities related to at least one quality metric for the plurality of UEs. The set of instructions, when executed by one or more processors of the network node, may cause the network node to allocate resources for the plurality of UEs in accordance with the content quality feedback received from the plurality of UEs. The set of instructions, when executed by one or more processors of the network node, may cause the network node to transmit, to each respective UE of the plurality of UEs, information related to the resources allocated to the respective UE.

Some aspects described herein relate to a non-transitory computer-readable medium that stores a set of instructions for wireless communication. The set of instructions, when executed by one or more processors of an application server, may cause the application server to receive, from a UE, content quality feedback indicating one or more of an estimated content quality or a target content quality related to at least one quality metric for one or more applications running at the UE. The set of instructions, when executed by one or more processors of the application server, may cause the application server to communicate with the UE using a resource allocation for the one or more applications running at the UE in accordance with the content quality feedback received from the UE.

Some aspects described herein relate to an apparatus for wireless communication. The apparatus may include means for communicating with a network node in accordance with a scheduling configuration, wherein the means for communicating with the network node includes one or more of means for transmitting or means for receiving traffic related to content for one or more applications. The apparatus may include means for transmitting, to the network node, content quality feedback indicating one or more of an estimated content quality or a target content quality related to at least one quality metric for the one or more applications.

Some aspects described herein relate to an apparatus for wireless communication. The apparatus may include means for communicating with a UE in accordance with a scheduling configuration, wherein the means for communicating with the UE includes one or more of means for transmitting or means for receiving traffic related to content for one or more applications. The apparatus may include means for receiving, from the UE, content quality feedback indicating one or more of an estimated content quality or a target content quality related to at least one quality metric for the one or more applications. The apparatus may include means for updating the scheduling configuration in accordance with the content quality feedback.

Some aspects described herein relate to an apparatus for wireless communication. The apparatus may include means for receiving, from a plurality of UEs, content quality feedback indicating one or more of estimated content qualities or target content qualities related to at least one quality metric for the plurality of UEs. The apparatus may include means for allocating resources for the plurality of UEs in accordance with the content quality feedback received from the plurality of UEs. The apparatus may include means for transmitting, to each respective UE of the plurality of UEs, information related to the resources allocated to the respective UE.

Some aspects described herein relate to an apparatus for wireless communication. The apparatus may include means for receiving, from a UE, content quality feedback indicating one or more of an estimated content quality or a target content quality related to at least one quality metric for one or more applications running at the UE. The apparatus may include means for communicating with the UE using a resource allocation for the one or more applications running at the UE in accordance with the content quality feedback received from the UE.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 illustrates an example wireless communication network.

FIG. 2 illustrates an example wireless communication network.

FIG. 3 illustrates an example wireless communication system.

FIG. 4 illustrates an example associated with multi-user content diversity.

FIG. 5 illustrates examples associated with improved user experience and improved system capacity enabled by multi-user content diversity.

FIG. 6 illustrates examples associated with improved user experience and improved system coverage enabled by multi-user content diversity.

FIG. 7 illustrates an example associated with multi-user content diversity.

FIG. 8 illustrates an example associated with multi-user content diversity.

FIGS. 9A-9B illustrate examples associated with signaling for multi-user content diversity.

FIG. 10 is a flowchart illustrating an example process performed, for example, at a user equipment (UE) or an apparatus of a UE that supports reporting application capabilities or content quality feedback.

FIG. 11 is a flowchart illustrating an example process performed, for example, at a network node or an apparatus of a network node that supports prioritizing traffic according to UE-reported application capabilities or content quality feedback.

FIG. 12 is a flowchart illustrating an example process performed, for example, at a network node or an apparatus of a network node that supports prioritizing traffic according to UE-reported application capabilities or content quality feedback.

FIG. 13 is a flowchart illustrating an example process performed, for example, at an application server or an apparatus of an application server that supports prioritizing traffic according to UE-reported content quality feedback.

FIG. 14 is a diagram of an example apparatus for wireless communication.

FIG. 15 is a diagram of an example apparatus for wireless communication.

FIG. 16 is a diagram of an example apparatus for wireless communication.

### DETAILED DESCRIPTION

As described herein, wireless communication networks use various techniques to schedule or allocate resources among multiple user equipment (UE) devices. For example, scheduling or resource allocation techniques include proportional fair scheduling to balance fairness and throughput among UEs according to current channel conditions, maximum carrier-to-interference scheduling to prioritize UEs with the best channel conditions to maximize throughput, or round-robin scheduling to allocate time slots equally among UEs regardless of channel conditions. Other scheduling or resource allocation techniques include beamforming and multiple-input multiple-output (MIMO) to allocate antennas and streams to different UEs to improve throughput and spectrum efficiency through spatial diversity, network slicing to create virtual networks with specific resource allocations for different services, or orthogonal frequency division multiple access (OFDMA) to allow simultaneous data transmission to different UEs by dividing channels into multiple sub-channels, among other examples.

Accordingly, in a radio access network (RAN) or a wireless local area network (WLAN), a network node or access point (AP) may utilize measurements, metrics, or other channel feedback that relates to conditions associated with a wireless channel (for example, a channel quality indicator (CQI)) to schedule UEs in a manner that exploits channel diversity to improve system capacity and user experience. In some examples, however, a wireless communication network may include significant traffic related to real-time and over-the-top (OTT) multimedia services, such as remote collaboration, video calls, video streaming, cloud gaming, immersive calling, or embodied robots, among other examples. In some examples, the multimedia services supported in a wireless communication network may have different sensitivities to variations in content quality. For example, two UEs receiving the same data rate might experience vastly different content quality due to differing application demands (for example, a first UE engaged in high-definition cloud gaming may suffer from a poor user experience due to the data rate being insufficient to satisfy the cloud gaming requirements, while a second UE running a less demanding application such as web browsing may receive more data than necessary).

However, multi-user scheduling algorithms that exploit channel diversity or other typical metrics are unable to address the potential imbalance between application demands and the actual, perceived, or projected content quality that users experience. Furthermore, wireless communication protocols generally lack well-established techniques to synchronize information about content quality at the UE and the network. Without mechanisms for signaling content quality, a network node in a RAN or an AP in a WLAN cannot make informed decisions to allocate resources or otherwise schedule UEs according to content quality demands or content quality estimates.

Various aspects relate generally to allocating resources or scheduling UEs in a wireless network according to content quality feedback. Some aspects more specifically relate to a signaling framework in which a UE communicates with a network node to indicate application capability information for one or more applications running on the UE, where the application capability information includes a set of supported values for one or more metrics that may impact or reflect content quality. Accordingly, in some aspects, the network node may leverage the application capability information in scheduling configurations or resource allocation decisions for one or more sessions that include communicating traffic related to content for the one or more applications. For example, in some aspects, the network node may allocate dedicated network resources to a UE or assign UEs with similar application capabilities to a group of UEs that share a dedicated network slice or resource allocation. Furthermore, during a session, an application running on the UE may estimate a historical, current, or future content quality experienced by the one or more applications, and the UE may signal the estimated content quality to the network node using content quality feedback. In addition, the application may provide the content quality feedback to an application server via Internet Protocol (IP) packets that are routed through the network node. Accordingly, the network node or the application server may adapt scheduling configurations or resource allocations among different UEs or UE sessions according to the estimated content quality relative to a target content quality. For example, the network node may prioritize scheduling or resource allocations for application content experiencing or projected to experience poor content quality (for example, failing to satisfy a target content quality) over application content experiencing or projected to experience good content quality (for example, exceeding the target content quality).

Particular aspects of the subject matter described in this disclosure can be implemented to realize one or more of the following potential advantages. In some examples, by prioritizing traffic for applications experiencing poor content quality, resources that are allocated to a UE or UE session experiencing content quality exceeding a demand can be reallocated to other UEs experiencing poor content quality, which improves user experience. In addition, by providing the content quality feedback to the network node, the described techniques enable intelligent scheduling configurations that distribute resources among multiple UEs according to estimated content qualities relative to desired or target content qualities, which improves overall system capacity and network coverage. For example, by allocating sufficient resources to satisfy content quality needs, network resources from UEs experiencing better than necessary content quality can be released and made available to accommodate additional UEs or UE sessions. Additionally or alternatively, resource allocations may be increased for UEs that are located closer to a cell edge, which increases coverage. Accordingly, by signaling content quality feedback from the UE to the network node, the network node can implement scheduling in a manner that exploits multi-user content diversity to improve user experience, increase system capacity, increase coverage, reduce network congestion, or reduce interference, among other examples.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

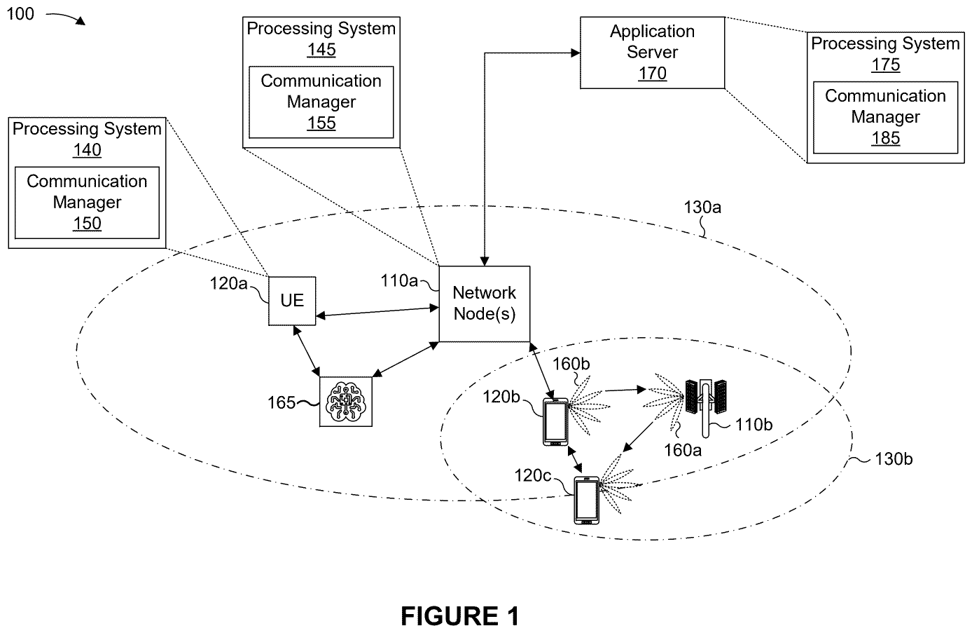

FIG. 1 is a diagram illustrating an example wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

As shown in FIG. 1, the wireless communication network 100 may include or may couple to an application server 170 that may host one or more applications and may receive, store, transmit, or otherwise communicate application data associated with the one or more applications. For example, the application server 170 may couple to one or more network nodes 110 (for example, via a core network) to receive or obtain application data from one or more UEs 120 or to transmit or send application data to one or more UEs 120. In some examples, a UE 120 may access an application hosted by the application server 170 via an application client installed on the UE 120, via a web browser installed on the UE 120, or in other suitable ways. In some examples, the application server 170 may include one or more server devices, one or more mobile edge compute (MEC) devices, one or more cloud computing devices, or other devices.

A network node 110, a UE 120, or an application server 170 may include one or more devices, components, or systems that enable communication with other devices, components, or systems of the wireless communication network 100. For example, a UE 120, a network node 110, and an application server 170 may each include one or more chips, system-on-chips (SoCs), chipsets, packages, or devices that individually or collectively constitute or comprise a processing system. As shown in FIG. 1, each UE 120 includes a processing system 140, each network node 110 includes a processing system 145, and the application server 170 includes a processing system 175. A processing system (for example, the processing system 140, the processing system 145, or processing system 175) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140, the processing system 145, and the processing system 175 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140, the processing system 145, and the processing system 175 may each include or be coupled with one or more modems (such as a cellular (for example, a 5G or 6G compliant) modem). In some examples, one or more processors of the processing system 140, the processing system 145, or processing system 175 may include or implement one or more of the modems. The processing system 140, the processing system 145, and the processing system 175 also may include or be coupled with multiple radios (collectively “the radio”), multiple RF chains, or multiple transceivers, each of which may in turn be coupled with one or more of multiple antennas. In some examples, one or more processors of the processing system 140, the processing system 145, or processing system 175 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140, by the processing system 145, or by the processing system 175).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an AP, a transmission reception point (TRP), a network entity, a network element, a network equipment, or another type of device, component, or system included in a RAN. In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a CQI (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may communicate with a network node 110 in accordance with a scheduling configuration, wherein communicating with the network node 110 includes one or more of transmitting or receiving traffic related to content for one or more applications; and transmit, to the network node 110, content quality feedback indicating one or more of an estimated content quality or a target content quality related to at least one quality metric for the one or more applications. Additionally, or alternatively, the communication manager 150 may perform one or more other operations described herein.

In some aspects, the network node 110 may include a communication manager 155. As described in more detail elsewhere herein, the communication manager 155 may communicate with a UE 120 in accordance with a scheduling configuration, wherein communicating with the UE 120 includes one or more of transmitting or receiving traffic related to content for one or more applications; receive, from the UE 120, content quality feedback indicating one or more of an estimated content quality or a target content quality related to at least one quality metric for the one or more applications; and update the scheduling configuration in accordance with the content quality feedback. Additionally, or alternatively, the communication manager 155 may receive, from a plurality of UEs 120, content quality feedback indicating one or more of estimated content qualities or target content qualities related to at least one quality metric for the plurality of UEs 120; allocate resources for the plurality of UEs 120 in accordance with the content quality feedback received from the plurality of UEs 120; and transmit, to each respective UE 120 of the plurality of UEs 120, information related to the resources allocated to the respective UE 120. Additionally, or alternatively, the communication manager 155 may perform one or more other operations described herein.

In some aspects, the application server 170 may include a communication manager 185. As described in more detail elsewhere herein, the communication manager 185 may receive, from a UE 120, content quality feedback indicating one or more of an estimated content quality or a target content quality related to at least one quality metric for one or more applications running at the UE 120; and communicate with the UE 120 using a resource allocation for the one or more applications running at the UE 120 in accordance with the content quality feedback received from the UE 120. Additionally, or alternatively, the communication manager 185 may perform one or more other operations described herein.

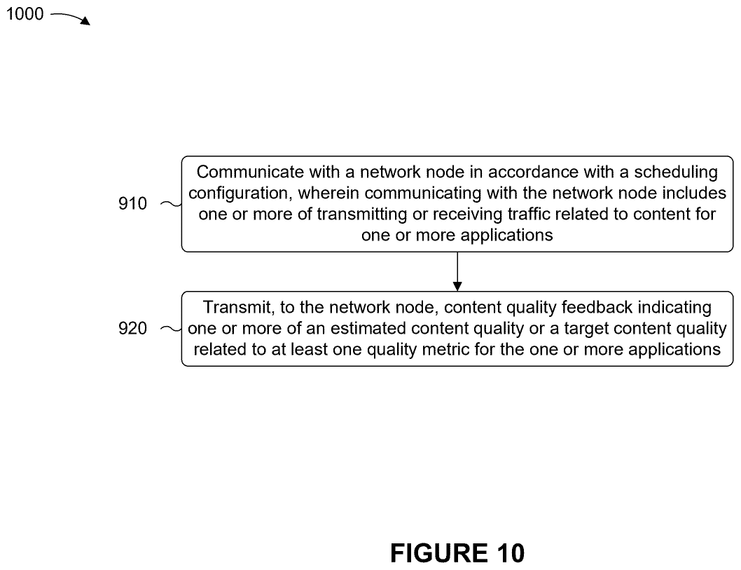

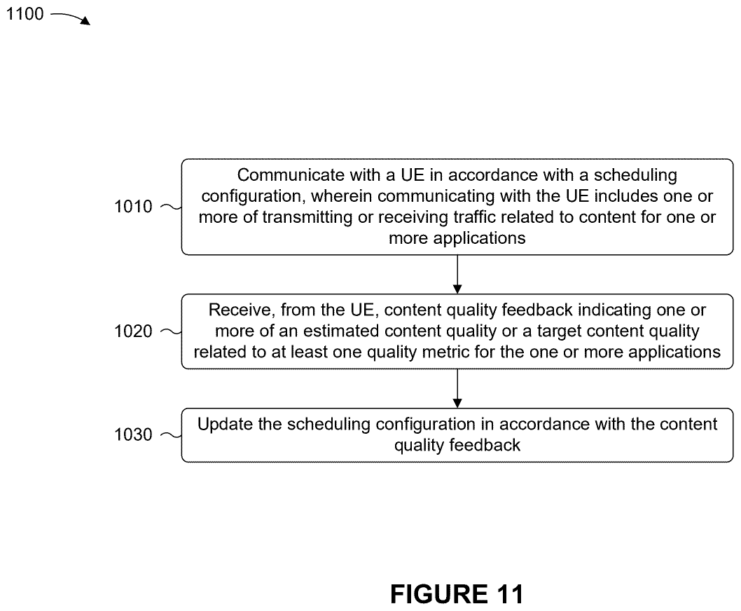

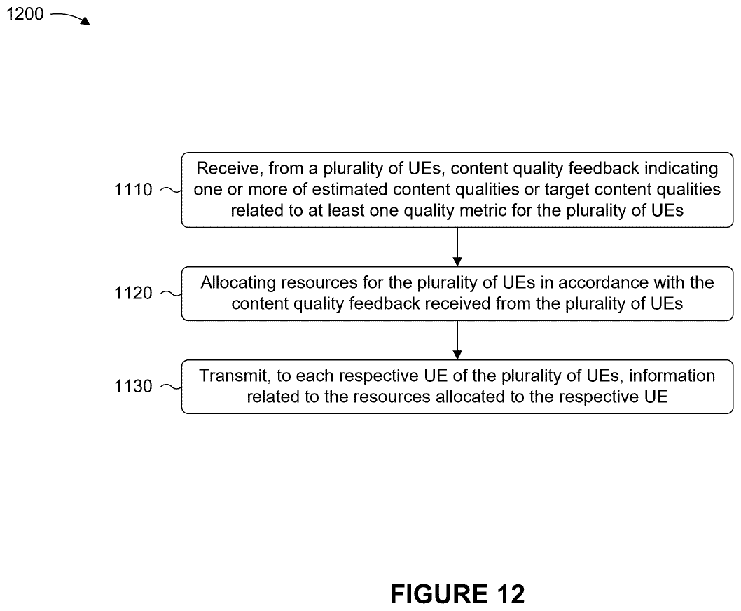

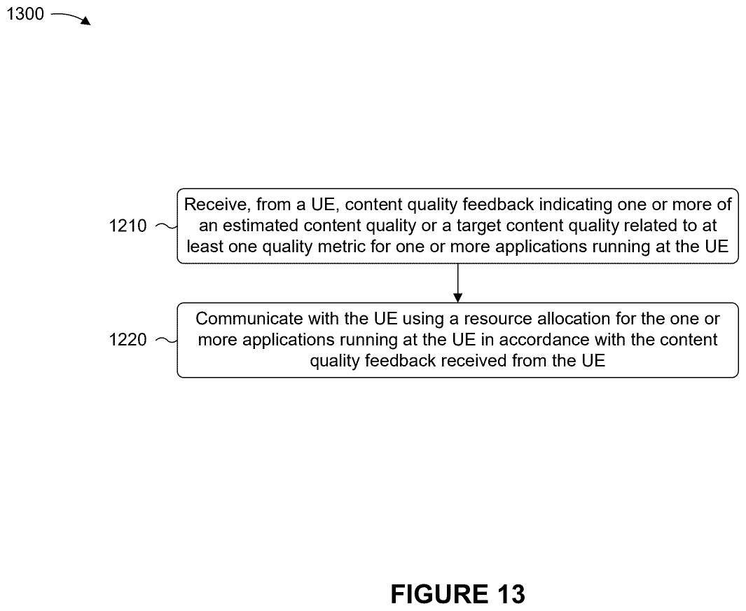

The network node 110, the processing system 145 of the network node 110, the UE 120, the processing system 140 of the UE 120, the application server 170, the processing system 175 of the application server 170, or any other component(s) of FIG. 1 may implement one or more techniques or perform one or more operations associated with multi-user content diversity, as described in more detail elsewhere herein. For example, the processing system 145 of the network node 110, the processing system 140 of the UE 120, or the processing system 175 of the application server 170 may perform or direct operations of, for example, process 1000 of FIG. 10, process 1100 of FIG. 11, process 1200 of FIG. 12, process 1300 of FIG. 13, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. Memory of an application server 170 may store data and program code (or instructions) for the UE 120, such as application-specific content information. In some examples, the memory of the UE 120, the memory of the network node 110, or the memory of the application server 170 may include a non-transitory computer-readable medium storing a set of instructions for wireless communication. For example, the set of instructions, when executed by one or more processors (for example, of the processing system 145, the processing system 140, or the processing system 175) of the network node 110, the UE 120, or the application server 170, may cause the one or more processors to perform process 1000 of FIG. 10, process 1100 of FIG. 11, process 1200 of FIG. 12, process 1300 of FIG. 13, or other processes as described herein. In some examples, executing instructions may include running the instructions, converting the instructions, compiling the instructions, or interpreting the instructions, among other examples.

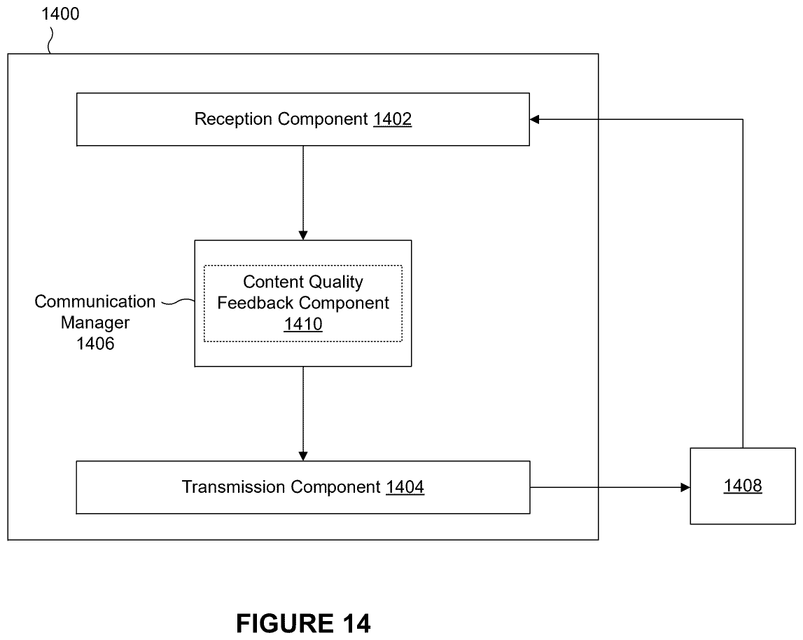

In some aspects, the UE 120 includes means for communicating with a network node 110 in accordance with a scheduling configuration, wherein the means for communicating with the network node 110 includes one or more of means for transmitting or means for receiving traffic related to content for one or more applications; or means for transmitting, to the network node 110, content quality feedback indicating one or more of an estimated content quality or a target content quality related to at least one quality metric for the one or more applications. The means for the UE 120 to perform operations described herein may include, for example, one or more of communication manager 150, processing system 140, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

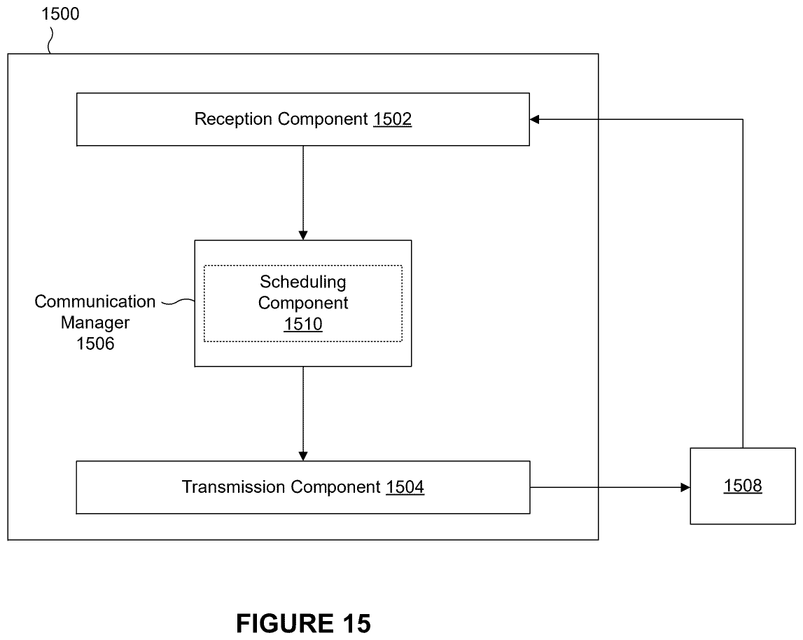

In some aspects, the network node 110 includes means for communicating with a UE 120 in accordance with a scheduling configuration, wherein the means for communicating with the UE 120 includes one or more of means for transmitting or means for receiving traffic related to content for one or more applications; means for receiving, from the UE 120, content quality feedback indicating one or more of an estimated content quality or a target content quality related to at least one quality metric for the one or more applications; or means for updating the scheduling configuration in accordance with the content quality feedback. Additionally or alternatively, the network node 110 includes means for receiving, from a plurality of UEs 120, content quality feedback indicating one or more of estimated content qualities or target content qualities related to at least one quality metric for the plurality of UEs 120; means for allocating resources for the plurality of UEs 120 in accordance with the content quality feedback received from the plurality of UEs 120; or means for transmitting, to each respective UE 120 of the plurality of UEs 120, information related to the resources allocated to the respective UE 120. The means for the network node 110 to perform operations described herein may include, for example, one or more of communication manager 155, processing system 145, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

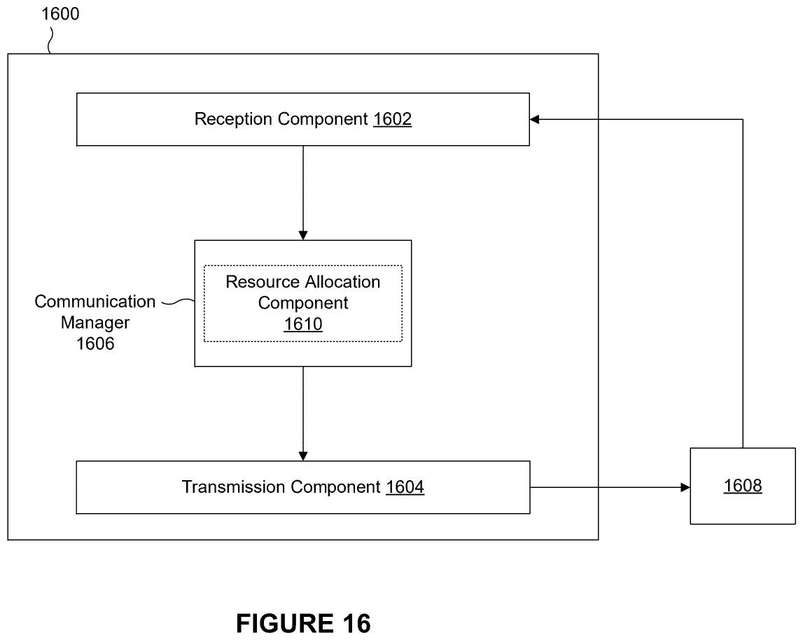

In some aspects, the application server 170 includes means for receiving, from a UE 120, content quality feedback indicating one or more of an estimated content quality or a target content quality related to at least one quality metric for one or more applications running at the UE 120; or means for communicating with the UE 120 using a resource allocation for the one or more applications running at the UE 120 in accordance with the content quality feedback received from the UE 120. In some aspects, the means for the application server 170 to perform operations described herein may include, for example, one or more of communication manager 185, processing system 175, a radio, one or more RF chains, one or more transceivers, one or more antennas, one or more modems, a reception component (for example, reception component 1602 depicted and described in connection with FIG. 16), or a transmission component (for example, transmission component 1604 depicted and described in connection with FIG. 16), among other examples.

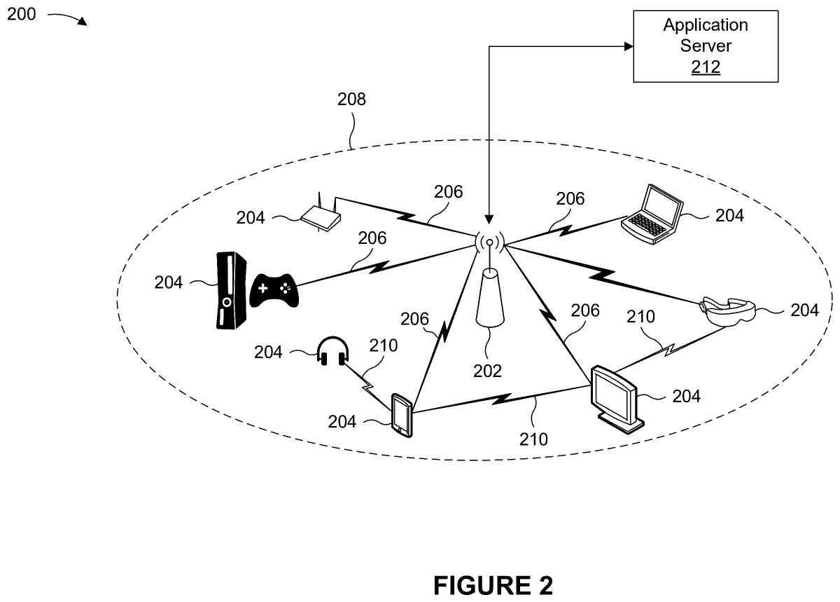

FIG. 2 illustrates an example wireless communication network 200. According to some aspects, the wireless communication network 200 can be an example of a WLAN, such as a Wi-Fi network. For example, the wireless communication network 200 can implement at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 200 can be an example of a cellular RAN, such as a 5G or 6G RAN that implements one or more cellular protocols such as those specified in one or more 3GPP standards (for example, as described above with reference to FIG. 1). In some other examples, the wireless communication network 200 can include a WLAN that functions in an interoperable or converged manner with one or more cellular RANs to provide greater or enhanced network coverage to wireless communication devices within the wireless communication network 200 or to enable such devices to connect to a core network in a cellular communication system, such as to access the network management capabilities and functionality offered by the core network. In some other examples, the wireless communication network 200 can include a WLAN that functions in an interoperable or converged manner with a personal area network (PAN), such as a network implementing Bluetooth or other wireless technologies, to provide greater or enhanced network coverage or to provide or enable other capabilities, functionality, applications, or services.

The wireless communication network 200 may include numerous wireless communication devices including at least one wireless AP 202 and any number of wireless stations (STAs) 204. While only one AP 202 is shown in FIG. 2, the wireless communication network 200 can include multiple APs 202. The AP 202 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a TRP or another type of device or equipment included in a RAN, including O-RAN network entities, such as a CU, a DU or an RU.

Each of the STAs 204 also may be referred to as a mobile station (MS), a mobile device, a mobile handset, a wireless handset, an access terminal (AT), a UE, a subscriber station (SS), or a subscriber unit, among other examples. The STAs 204 may represent various devices such as mobile phones, other handheld or wearable communication devices, netbooks, notebook computers, tablet computers, laptops, augmented reality (AR), virtual reality (VR), mixed reality (MR) or XR wireless headsets or other peripheral devices, wireless earbuds, other wearable devices, display devices (for example, televisions, computer monitors, or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), IoT devices, and vehicles, among other examples.

A single AP 202 and an associated set of STAs 204 may be referred to as a basic service set (BSS), which is managed by the respective AP 202. FIG. 2 additionally shows an example coverage area 208 of the AP 202, which may represent a basic service area (BSA) of the wireless communication network 200. The BSS may be identified by STAs 204 and other devices by a service set identifier (SSID), as well as a basic service set identifier (BSSID), which may be a MAC address of the AP 202. The AP 202 may periodically broadcast beacon frames (“beacons”) including the BSSID to enable any STAs 204 within wireless range of the AP 202 to “associate” or re-associate with the AP 202 to establish a respective communication link 206 (hereinafter also referred to as a “Wi-Fi link”), or to maintain a communication link 206, with the AP 202. For example, the beacons can include an identification or indication of a primary channel used by the respective AP 202 as well as a timing synchronization function (TSF) for establishing or maintaining timing synchronization with the AP 202. The AP 202 may provide access to external networks to various STAs 204 in the wireless communication network 200 via respective communication links 206.

To establish a communication link 206 with an AP 202, each of the STAs 204 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 204 listens for beacons, which are transmitted by respective APs 202 at periodic time intervals referred to as target beacon transmission times (TBTTs). To perform active scanning, a STA 204 generates and sequentially transmits probe requests on each channel to be scanned and listens for probe responses from APs 202. Each STA 204 may identify, determine, ascertain, or select an AP 202 with which to associate in accordance with the scanning information obtained through the passive or active scans, and to perform authentication and association operations to establish a communication link 206 with the selected AP 202. The selected AP 202 assigns an association identifier (AID) to the STA 204 at the culmination of the association operations, which the AP 202 uses to track the STA 204.

As a result of the increasing ubiquity of wireless networks, a STA 204 may have the opportunity to select one of many BSSs within range of the STA 204 or to select among multiple APs 202 that together form an extended service set (ESS) including multiple connected BSSs. For example, the wireless communication network 200 may be connected to a wired or wireless distribution system that may enable multiple APs 202 to be connected in such an ESS. As such, a STA 204 can be covered by more than one AP 202 and can associate with different APs 202 at different times for different transmissions. Additionally, after association with an AP 202, a STA 204 also may periodically scan its surroundings to find a more suitable AP 202 with which to associate. For example, a STA 204 that is moving relative to its associated AP 202 may perform a “roaming” scan to find another AP 202 having more desirable network characteristics such as a greater RSSI or a reduced traffic load.

In some examples, STAs 204 may form networks without APs 202 or other equipment other than the STAs 204 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 200. In such examples, while the STAs 204 may be capable of communicating with each other through the AP 202 using communication links 206, STAs 204 also can communicate directly with each other via direct wireless communication links 210. Additionally, two STAs 204 may communicate via a direct wireless communication link 210 regardless of whether both STAs 204 are associated with and served by the same AP 202. In such an ad hoc system, one or more of the STAs 204 may assume the role filled by the AP 202 in a BSS. Such a STA 204 may be referred to as a group owner (GO) and may coordinate transmissions within the ad hoc network. Examples of direct wireless communication links 210 include Wi-Fi Direct connections, connections established by using a Wi-Fi Tunneled Direct Link Setup (TDLS) link, and other P2P group connections.

In some networks, the AP 202 or the STAs 204, or both, may support applications associated with high throughput or low-latency requirements, or may provide lossless audio to one or more other devices. For example, the AP 202 or the STAs 204 may support applications and use cases associated with ultra-low-latency (ULL), such as ULL gaming, or streaming lossless audio and video to one or more personal audio devices (such as peripheral devices) or XR headset devices. In scenarios in which a user uses two or more peripheral devices, the AP 202 or the STAs 204 may support an extended personal audio network enabling communication with the two or more peripheral devices. Additionally, the AP 202 and STAs 204 may support additional ULL applications such as cloud-based applications (such as VR cloud gaming) that have ULL and high throughput requirements.

As indicated above, in some implementations, the AP 202 and the STAs 204 may function and communicate (via the respective communication links 206) according to one or more of the IEEE 802.11 family of wireless communication protocol standards. These standards define the WLAN radio and baseband protocols for the PHY and MAC layers. The AP 202 and STAs 204 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 202 and STAs 204 in the wireless communication network 200 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 202 and STAs 204 described herein also may communicate in other frequency bands that may support licensed or unlicensed communications. For example, the APs 202 or STAs 204, or both, also may be capable of communicating over licensed operating bands, where multiple operators may have respective licenses to operate in the same or overlapping frequency ranges. Such licensed operating bands may map to or be associated with frequency range designations of FR1, FR2, FR3, FR4a or FR4-1, FR4, and FR5.

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 202 may determine or select an operating or operational bandwidth for the STAs 204 in its BSS and select a range of channels within a band to provide that operating bandwidth. For example, the AP 202 may select sixteen 20 MHz channels that collectively span an operating bandwidth of 320 MHz. Within the operating bandwidth, the AP 202 may typically select a single primary 20 MHz channel on which the AP 202 and the STAs 204 in its BSS monitor for contention-based access schemes. In some examples, the AP 202 or the STAs 204 may be capable of monitoring only a single primary 20 MHz channel for packet detection (for example, for detecting preambles of PPDUs). Conventionally, any transmission by an AP 202 or a STA 204 within a BSS must involve transmission on the primary 20 MHz channel. As such, in conventional systems, the transmitting device must contend on and win a TXOP on the primary channel to transmit anything at all. However, some APs 202 and STAs 204 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

In some examples, as shown in FIG. 2, an AP 202 may communicate with an application server 212 that may host one or more applications and receive, store, transmit, or otherwise communicate application data associated with the one or more applications. For example, the application server 212 may couple to the AP 202 (for example, via a core network, a data network, or other suitable networks or links) to receive or obtain application data from one or more STAs 204 or to transmit or send application data to one or more STAs 204. In some examples, an STA 204 may access an application hosted by the application server 212 via an application client installed on the STA 204, via a web browser installed on the STA 204, or in other suitable ways. In some examples, the application server 212 includes, is an example of, or implements one or more features of the application server 170 in FIG. 1.

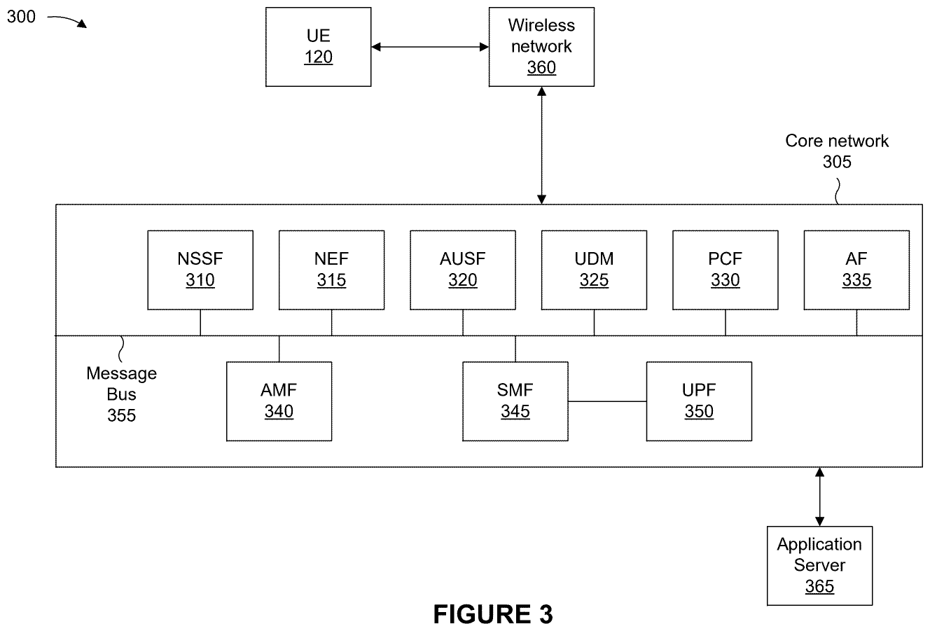

FIG. 3 illustrates an example wireless communication system 300. As shown in FIG. 3, the wireless communication system 300 may include a UE 120, a core network 305, a wireless network 360, and an application server 365. In some examples, the application server 365 includes, is an example of, or implements one or more features of the application server 170 in FIG. 1 or the application server 212 in FIG. 2. Devices or networks of the wireless communication system 300 may interconnect via wired connections, wireless connections, or a combination thereof.

In some examples, the wireless network 360 includes, is an example of, or implements one or more features of the wireless communication network 100 in FIG. 1 or the wireless communication network 200 in FIG. 2. For example, the wireless network 360 may support, for example, a cellular RAT or a WLAN RAT. The wireless network 360 may include one or more network nodes 110 that can support wireless communication for the UE 120. The wireless network 360 may transfer traffic between the UE 120 (for example, using a cellular or WLAN RAT), one or more network nodes 110 (for example, using a wireless interface or a backhaul interface, such as a wired backhaul interface), the core network 305, or the application server 365. The wireless network 360 may provide one or more cells that cover geographic areas.

In some aspects, the wireless network 360 may perform scheduling or resource management for the UE 120 covered by the wireless network 360 (for example, the UE 120 covered by a cell provided by the wireless network 360). In some aspects, the wireless network 360 may be controlled or coordinated by a network controller that may perform load balancing or network-level configuration, among other examples. The network controller may communicate with the wireless network 360 via a wireless or wireline backhaul. In some aspects, the wireless network 360 may include a network controller, an SON module or component, or a similar module or component. Accordingly, the wireless network 360 may perform network control, scheduling, or network management functions (for example, for uplink, downlink, or sidelink communications of the UE 120 covered by the wireless network 360).

In some aspects, the core network 305 may include an example functional architecture in which systems or methods described herein may be implemented. For example, the core network 305 may include an example architecture of a core network included in a 5G, 6G, or other suitable wireless telecommunications system. Although the example architecture of the core network 305 shown in FIG. 3 is an example of a service-based architecture, in some aspects, the core network 305 may be implemented as a reference-point architecture or another suitable core network architecture.

As shown in FIG. 3, the core network 305 may include various functional elements. The functional elements may include, for example, a network slice selection function (NSSF) 310, a network exposure function (NEF) 315, an authentication server function (AUSF) 320, a unified data management (UDM) component 325, a policy control function (PCF) 330, an application function (AF) 335, an access and mobility management function (AMF) 340, a session management function (SMF) 345, or a user plane function (UPF) 350, among other examples. The functional elements may be communicatively connected via a message bus 355. Each of the functional elements shown in FIG. 3 may be implemented on one or more devices associated with a wireless telecommunications system. In some implementations, one or more of the functional elements may be implemented on physical devices, such as an access point, a network node, or a gateway, among other examples. In some implementations, one or more of the functional elements may be implemented on a computing device of a cloud computing environment.

The NSSF 310 may include one or more devices that select network slice instances for the UE 120. Network slicing is a network architecture model in which logically distinct network slices operate using common network infrastructure. For example, several network slices may operate as isolated end-to-end networks customized to satisfy different target service standards for different types of applications executed, at least in part, by the UE 120 or communications to and from the UE 120. Network slicing may efficiently provide communications for different types of services with different service standards.

The NSSF 310 may determine a set of network slice policies to be applied at the wireless communication network 100. For example, the NSSF 310 may apply one or more UE route selection policy (URSP) rules. In some aspects, the NSSF 310 may select a network slice based on a mapping of a data network name (DNN) field included in a route selection description (RSD) to the DNN field included in a traffic descriptor selected by the UE 120. By providing network slicing, the NSSF 310 allows an operator to deploy multiple substantially independent end-to-end networks potentially with the same infrastructure. In some implementations, each slice may be customized for different services.

The NEF 315 may include one or more devices that support exposure of capabilities or events in the wireless telecommunications system to help other entities in the wireless telecommunications system discover network services. The AUSF 320 may include one or more devices that act as an authentication server and support the process of authenticating the UE 120 in the wireless telecommunications system.

The UDM 325 may include one or more devices that store user data and profiles in the wireless telecommunications system. In some aspects, the UDM 325 may be used for fixed access or mobile access, among other examples, in the core network 305.

The PCF 330 may include one or more devices that provide a policy framework that incorporates network slicing, roaming, packet processing, or mobility management, among other examples. In some aspects, the PCF 330 may include one or more URSP rules used by the NSSF 310 to select network slice instances for the UE 120.

The AF 335 may include one or more devices that support application influence on traffic routing, access to the NEF 315, or policy control, among other examples. The AMF 340 may include one or more devices that act as a termination point for non-access stratum (NAS) signaling or mobility management, among other examples. In some aspects, the AMF may request the NSSF 310 to select network slice instances for the UE 120, for example, at least partially in response to a request for data service from the UE 120.

The SMF 345 may include one or more devices that support the establishment, modification, and release of communication sessions in the wireless telecommunications system. For example, the SMF 345 may configure traffic steering policies at the UPF 350 or enforce UE IP address allocation and policies, among other examples. In some aspects, the SMF 345 may provision the network slice instances selected by the NSSF 310 for the UE 120.

The UPF 350 may include one or more devices that serve as an anchor point for intra-RAT or inter-RAT mobility. In some aspects, the UPF 350 may apply rules to packets, such as rules pertaining to packet routing, traffic reporting, or handling user plane QoS, among other examples. In some examples, the UPF 350 may transfer user plane data associated with one or more applications to and from the application server 365.

The message bus 355 may be a logical or physical communication structure for communication among the functional elements. Accordingly, the message bus 355 may permit communication between two or more functional elements, whether logically (for example, using one or more APIs, among other examples) or physically (for example, using one or more wired or wireless connections).

The number and arrangement of devices and networks shown in FIG. 3 are provided as an example. In practice, there may be additional devices or networks, fewer devices or networks, different devices or networks, or differently arranged devices or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (for example, one or more devices) of example 300 may perform one or more functions described as being performed by another set of devices of example system 300.

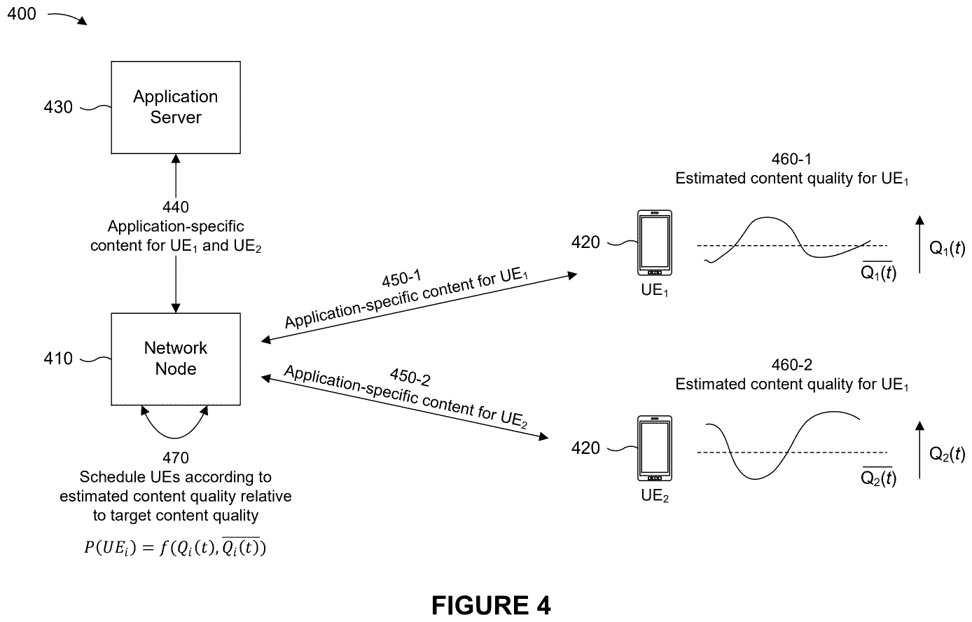

FIG. 4 illustrates an example 400 associated with multi-user content diversity. As shown in FIG. 4, example 400 includes communication between a network node 410, multiple UEs 420 (shown as UE₁ and UE₂), and an application server 430. The network node 410 may correspond to a network node 110 shown in FIG. 1 (for example, a RAN node, such as a CU, a DU, or an RU), an AP 202 shown in FIG. 2, or a core network device shown in FIG. 3. The UEs 420 may correspond to a UE 120 shown in FIG. 1 or an STA 204 shown in FIG. 2. The application server 430 may correspond to the application server 170 shown in FIG. 1, the application server 212 shown in FIG. 2, or the application server 365 shown in FIG. 3. In some aspects, the network node 410 and the UEs 420 may communicate in a wireless network, such as wireless communication network 100 or wireless communication network 200, or wireless communication system 300.

As described herein, the network node 420 may use various techniques to schedule or allocate resources among the multiple UEs 420. For example, scheduling or resource allocation techniques implemented by the network node 420 may include proportional fair scheduling to balance fairness and throughput among the UEs 420 according to current channel conditions, maximum carrier-to-interference scheduling to prioritize UEs 420 with the best channel conditions to maximize throughput, or round-robin scheduling to allocate time slots equally among the UEs 420 regardless of channel conditions. Other scheduling or resource allocation techniques include beamforming and MIMO to allocate antennas and streams to different UEs 420 to improve throughput and spectrum efficiency through spatial diversity, network slicing to create virtual networks with specific resource allocations for different services, or OFDMA to allow simultaneous data transmission to different UEs 420 by dividing channels into multiple sub-channels, among other examples.

Accordingly, the network node 110 may generally utilize measurements, metrics, or other channel feedback that relates to conditions associated with a wireless channel (for example, a CQI) to schedule the UEs 420 in a manner that exploits channel diversity to improve system capacity and user experience. In some examples, a wireless communication network may include significant traffic related to real-time and OTT multimedia services, such as remote collaboration, video calls, video streaming, cloud gaming, immersive calling, or embodied robots, among other examples. For example, in an operation 440 shown in FIG. 4, the network node 410 may communicate with the application server 430 to exchange application-specific content (for example, user plane traffic) for one or more applications running on a first UE 420 (shown as UE₁) and a second UE (shown as UE₂). In an operation 450, the network node 110 may communicate with the UEs 420 to transfer the application-specific content. For example, the network node 110 may communicate with the first UE 420 to transfer the application-specific content for the first UE 420 in an operation 450-1, and may communicate with the second UE 420 to transfer the application-specific content for the second UE 420 in an operation 450-2 that may occur at the same time as or a different time than operation 450-1. In some aspects, the operation 440 and the operation 450 may generally be performed in any suitable order. For example, for downlink traffic, the network node 410 may receive the application-specific content from the application server 430 in operation 440, and then transmit the application-specific content to a UE 420 in operation 450. Alternatively, for uplink traffic, the network node 410 may receive the application-specific content from a UE 420 in operation 450, and then send the application-specific content to the application server 430 in operation 450.

In some examples, the multimedia services (and other services) supported in a wireless communication network may have different sensitivities to variations in content quality. For example, the first UE 420 and the second UE 420 may be allocated the same data rate and nonetheless experience different content qualities due to differing application demands. For example, the first UE 420 may be engaged in high-definition cloud gaming and may suffer from a poor user experience due to the data rate being insufficient to satisfy the cloud gaming requirements, while the second UE 420 may be running a less demanding application such as web browsing and the data rate may be higher than necessary to achieve a desired or target content quality. For example, as shown in FIG. 4, the first UE 120 may experience a first estimated content quality 460-1, denoted Q̅₁̅(̅t̅)̅, that fails to satisfy a desired or target content quality, denoted Q₁(t), resulting in a poor user experience. However, despite receiving the same data rate, the second UE 120 may experience a second estimated content quality 460-2, denoted Q̅₂̅(̅t̅)̅, that exceeds the desired or target content quality, denoted Q₂(t), due to the application(s) running on the UE 420 having a lower content quality demand. In some aspects, as described herein, the estimated content qualities 460 may be actual content qualities that are estimated according to traffic histories, current content qualities estimated according to current metrics, or projected (future) content qualities that are estimated according to one or more inferencing or prediction techniques.

Accordingly, as described herein, the network node 410 may implement a multi-user scheduling algorithm that addresses the potential imbalance between application demands and the actual, perceived, or projected content qualities that different UEs 420 experience or are expected (for example, projected) to experience. For example, in some aspects, the network node 410 and the UEs 420 may communicate using a signaling framework to synchronize content quality feedback at the UE 420 and the network node 410 (and the application server 430 in some examples). For example, in some aspects, each UE 420 may communicate with the network node 410 to indicate application capability information for one or more applications running on the UE 420, where the application capability information includes a set of supported values for one or more metrics that may impact or reflect content quality. Accordingly, the network node 410 may leverage the application capability information in scheduling configurations or resource allocation decisions for one or more sessions that include communicating traffic related to content for the one or more applications. For example, in some aspects, the network node 410 may allocate dedicated network resources to a UE 420 or assign UEs 420 with similar application capabilities to a group of UEs 420 that share a dedicated network slice or resource allocation.

Furthermore, an application running on a UE 420 may estimate a historical, current, or future content quality experienced by one or more applications during an application session, and the UE 420 may signal the estimated content quality to the network node 410 using content quality feedback. In addition, the application may provide the content quality feedback to the application server 430 via IP packets that are routed through the network node 410. Accordingly, in an operation 470, the network node 410 may adapt scheduling configurations or resource allocations among different UEs 420 or UE sessions according to the estimated content quality relative to a target content quality. For example, the network node 410 may prioritize scheduling or resource allocations for application content experiencing or projected to experience poor content quality (for example, failing to satisfy a target content quality) over application content experiencing or projected to experience good content quality (for example, exceeding the target content quality). For example, as shown in FIG. 4, the priority assigned to each UE 420, denoted P(UEᵢ), may be a function of (for example, inversely proportional to) the estimated content quality, Q̅ᵢ̅(̅t̅)̅, and the desired or target content quality, Qᵢ(t). In this way, by prioritizing traffic for applications experiencing poor content quality, resources that are allocated to a UE 420 or UE session experiencing content quality exceeding a demand can be reallocated to other UEs 420 experiencing poor content quality, which improves user experience. In addition, by providing the content quality feedback to the network node, the described techniques enable intelligent scheduling configurations that distribute resources among multiple UEs 420 according to estimated content qualities relative to desired or target content qualities, which improves overall system capacity and network coverage. For example, by allocating sufficient resources to satisfy content quality needs, network resources from UEs 420 experiencing better than necessary content quality can be released and made available to accommodate additional UEs 420 or UE sessions. Additionally or alternatively, resource allocations may be increased for UEs 420 that are located closer to a cell edge, which increases coverage. Accordingly, by signaling content quality feedback from the UE 420 to the network node 410, the network node 410 can implement scheduling in a manner that exploits multi-user content diversity to improve user experience, increase system capacity, increase coverage, reduce network congestion, or reduce interference, among other examples.

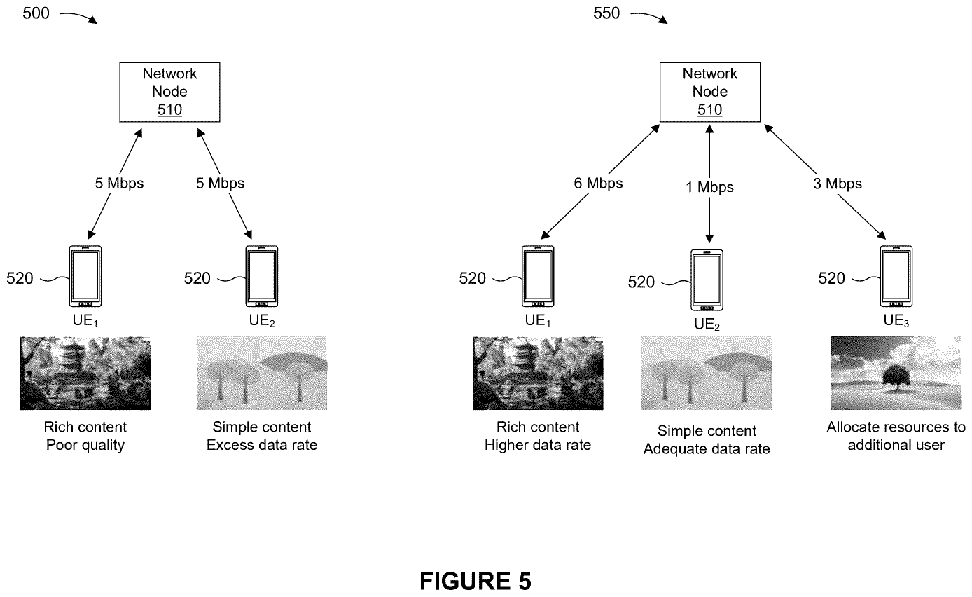

FIG. 5 illustrates examples 500 and 550 associated with improved system performance and improved system capacity using multi-user content diversity. As shown in FIG. 5, examples 500 and 550 include communication between a network node 510 and multiple UEs 520 (shown as UE₁, UE₂, and UE₃). The network node 510 may correspond to a network node 110 shown in FIG. 1 (for example, a RAN node, such as a CU, a DU, or an RU), an AP 202 shown in FIG. 2, or a core network device shown in FIG. 3. The UEs 520 may correspond to a UE 120 shown in FIG. 1 or an STA 204 shown in FIG. 2. In some aspects, the network node 510 and the UEs 520 may communicate in a wireless network, such as wireless communication network 100 or wireless communication network 200, or wireless communication system 300.

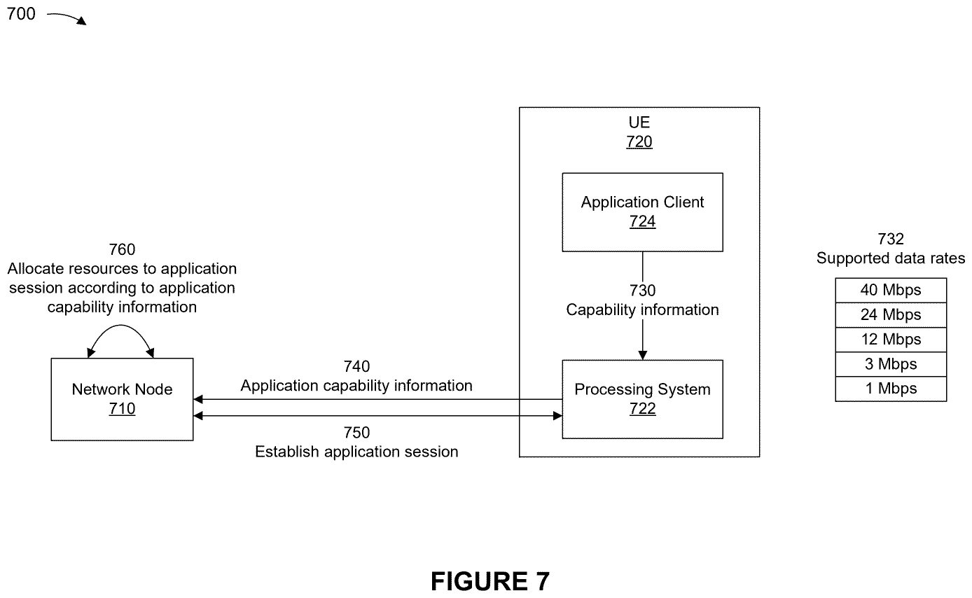

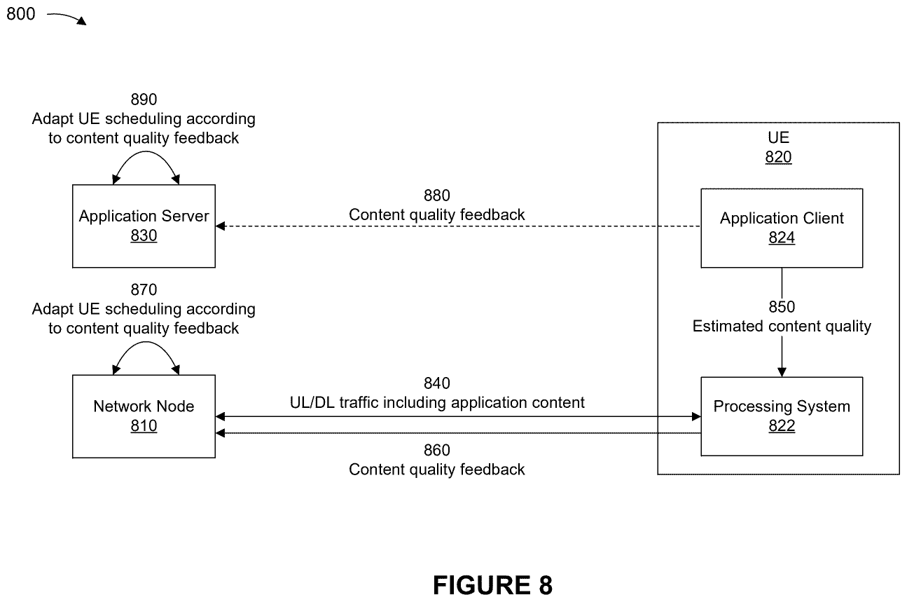

In some aspects, the network node 510 may implement a multi-user scheduling algorithm that addresses potential imbalances between application demands and actual, perceived, or projected content qualities that different UEs 520 experience or are expected (for example, projected) to experience over time. For example, in some aspects, the network node 510 and the UEs 520 may communicate using a signaling framework to synchronize content quality feedback at the UE 520 and the network node 510 (and an application server, in some examples), as described in further detail herein with reference to FIG. 7 and FIG. 8. In general, the signaling framework may enable the network node 110 to be aware of content qualities that impact application performance or user experience at the UEs 520, such that the network node 510 can intelligently distribute resources among the UEs 520 according to estimated content qualities relative to desired or target content qualities.

For example, by allocating sufficient resources to satisfy content quality needs, network resources from one or more UEs 520 that are experiencing better than necessary content quality can be released and made available to accommodate additional UEs 520 or UE sessions. For example, referring to FIG. 5, example 500 depicts a first communication state, where the network node 510 has allocated the same data rate or bit rate (for example, 5 megabits per second (Mbps)) to a first UE 520 executing an application that involves rich content (for example, a multimedia streaming application, an online gaming application, or another suitable application) and to a second UE 520 executing an application that involves relatively simple content (for example, a web browsing application or another suitable application). As shown in example 500, despite having the same data rate, the first UE 520 experiences poor content quality (for example, the data rate is insufficient to satisfy a desired or target content quality) and the second UE 520 experiences content quality that is higher than necessary for suitable application performance or user experience (for example, the data rate exceeds a data rate needed to satisfy a desired or target content quality).

Accordingly, as described herein, the first UE 520 and the second UE 520 may each provide content quality feedback to the network node 510, where the content quality feedback from the first UE 520 indicates that the estimated content quality fails to satisfy a desired or target content quality for one or more applications running on the first UE 520, and the content quality feedback from the second UE 520 indicates that the estimated content quality exceeds a desired or target content quality for one or more applications running on the second UE 520. As shown in example 550, the network node 510 may utilize the content quality feedback from the first UE 520 and the second UE 520 to dynamically adjust scheduling configurations or reallocate resources among the first UE 520 and the second UE 520. For example, as shown, the network node 510 decreases a data rate for the second UE 520 to a level (for example, 1 Mbps) that is still sufficient to satisfy a desired or target content quality, and increases a data rate for the first UE 520 to a level (for example, 6 Mbps) such that the content quality at the first UE 520 satisfies the desired or target content quality. Furthermore, in example 550, the total resources distributed among the first UE 520 and the second UE 520 (for example, 7 Mbps) is lower relative to the total resources distributed among the first UE 520 and the second UE 520 in example 500 (for example, 10 Mbps). Accordingly, the reallocation or redistribution of resources among the first UE 520 and the second UE 520 frees resources (for example, up to 3 Mbps) that can accommodate additional users, such as a third UE 520, thereby improving system capacity.

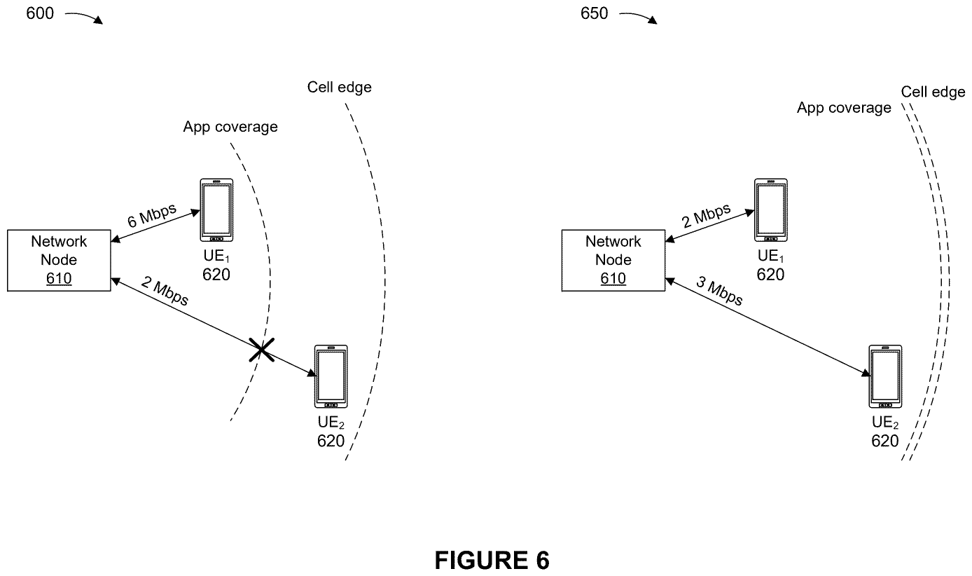

FIG. 6 illustrates examples 600 and 650 associated with improved system coverage using multi-user content diversity. As shown in FIG. 6, examples 600 and 650 include communication between a network node 610 and multiple UEs 620 (shown as UE₁ and UE₂). The network node 610 may correspond to a network node 110 shown in FIG. 1 (for example, a RAN node, such as a CU, a DU, or an RU), an AP 202 shown in FIG. 2, or a core network device shown in FIG. 3. The UEs 620 may correspond to a UE 120 shown in FIG. 1 or an STA 204 shown in FIG. 2. In some aspects, the network node 610 and the UEs 620 may communicate in a wireless network, such as wireless communication network 100 or wireless communication network 200, or wireless communication system 300.

In some aspects, the network node 610 may implement a multi-user scheduling algorithm that addresses potential imbalances between application demands and actual, perceived, or projected content qualities that different UEs 620 experience or are expected (for example, projected) to experience over time. For example, in some aspects, the network node 610 and the UEs 620 may communicate using a signaling framework to synchronize content quality feedback at the UE 620 and the network node 610 (and an application server, in some examples), as described in further detail herein with reference to FIG. 7 and FIG. 8. In general, the signaling framework may enable the network node 110 to be aware of content qualities that impact application performance or user experience at the UEs 620, such that the network node 610 can intelligently distribute resources among the UEs 620 according to estimated content qualities relative to desired or target content qualities.

For example, by allocating sufficient resources to satisfy content quality needs, network resources from one or more UEs 620 that are experiencing better than necessary content quality can be released and made available to accommodate UEs 620 experiencing more challenging channel conditions, thereby improving coverage. For example, referring to FIG. 6, example 600 depicts a first communication state, where the network node 610 has allocated a first data rate or bit rate (for example, 6 Mbps) to a first UE 620 and a second data rate or bit rate (for example, 2 Mbps) to a second UE 620. In some aspects, the lower data rate assigned to the second UE 620 may effectively reduce the application coverage area within a cell. For example, the second UE 620 that is located closer to the cell edge may need a larger resource allocation (for example, higher bit rate) to satisfy a desired or target content quality, and the insufficient resource allocation may deteriorate the application coverage.

Accordingly, as described herein, the first UE 620 and the second UE 620 may each provide content quality feedback to the network node 610, where the content quality feedback from the first UE 620 indicates that the estimated content quality exceeds a desired or target content quality for one or more applications running on the first UE 620, and the content quality feedback from the second UE 620 indicates that the estimated content quality fails to satisfy a desired or target content quality for one or more applications running on the second UE 620. As shown in example 650, the network node 610 may utilize the content quality feedback from the first UE 620 and the second UE 620 to dynamically adjust scheduling configurations or reallocate resources among the first UE 620 and the second UE 620 to satisfy desired or target content qualities for each UE 620. For example, as shown, the network node 610 decreases a data rate for the first UE 620 to a level (for example, from 6 Mbps to 2 Mbps) that is still sufficient to satisfy the desired or target content quality, and increases the data rate for the second UE 620 (for example, from 2 Mbps to 3 Mbps) such that the content quality at the second UE 620 satisfies the desired or target content quality. In this way, the second UE 620 at the cell edge may be allocated more resources to satisfy the desired or target content quality, which leads to improved user experience and improved coverage for the applications running on each UE 620.

FIG. 7 illustrates an example 700 associated with a setup phase for multi-user content diversity. As shown in FIG. 7, example 700 includes communication between a network node 710 and a UE 720 that includes a processing system 722 and one or more application clients 724. In some aspects, the network node 710 may correspond to a network node 110 shown in FIG. 1 (for example, a RAN node, such as a CU, a DU, or an RU), an AP 202 shown in FIG. 2, or a core network device shown in FIG. 3. The UE 720 may correspond to a UE 120 shown in FIG. 1 or an STA 204 shown in FIG. 2, and the processing system 722 may correspond to the processing system 140 shown in FIG. 1. In some aspects, the network node 710 and the UE 720 may communicate in a wireless network, such as wireless communication network 100 or wireless communication network 200, or wireless communication system 300.

As shown in FIG. 7, in a first operation 730, an application client 724 executing on the UE 720 may indicate capability information for the application client 724 to the processing system 722. For example, in some aspects, the capability information may indicate a set of values supported by the application client 724. In some aspects, the set of values supported by the application client 724 may generally correspond to values for one or more metrics that indicate or reflect a content quality that is sufficient to satisfy a demand associated with the application client 724. For example, FIG. 7 illustrates example capability information 732 indicating that bit rates of 40 Mbps, 24 Mbps, 12 Mbps, 3 Mbps, and 1 Mbps each provide sufficient content quality to satisfy a demand associated with the application client 724. In other examples, the capability information indicated by the application client 724 may include supported values for other suitable metrics, such as resolution, frames per second (FPS), peak signal-to-noise ratio (PSNR), stalls, jitter, video multimethod assessment fusion (VMAF), latency, video startup time, or buffering ratio, among other examples.

As further shown in FIG. 7, in a second operation 740, the UE 720 may transmit, and the network node 710 may receive, the application capability information for one or more application clients running on the UE 720. For example, in some aspects, the UE 720 may transmit the application capability information using an RF component, a modem, or other suitable components of the processing system 722. In some aspects, the application capability information may be transmitted in any suitable message, such as an RRC message or a MAC-CE message, an augmented, overloaded, or punctured PUCCH or PUSCH, a NAS message, a WLAN frame (for example, an 802.11 frame), or a standard communication with network elements (SCONE) message, among other examples. In some aspects, the network node 710 may store the application capability information for the UE 720, such that the application capability information may be referenced when scheduling or allocating resources to a session associated with an application 724 executing on the UE 720. Furthermore, in some aspects, the UE 720 may periodically update the application capability information with the network node 710 or update the application capability information in an aperiodic manner (for example, upon request by the network node 710), among other examples. In some aspects, the application capability information reported to the network node 710 may indicate a selected value for one or more content quality metrics or a preferred value for one or more content quality metrics.

For example, in a third operation 750, the UE 720 may communicate with the network node 710 to establish a session for one or more applications 724 executing on the UE 720. Accordingly, in a fourth operation 760, the network node 710 may allocate resources to the application session according to the application capability information that the UE 720 reported for the one or more applications 724. For example, referring to the example capability information 732, the network node 710 may allocate a 1 Mbps bit rate, a 3 Mbps bit rate, or another suitable bit rate to the session from the set of values that are supported by the application(s) 724 associated with the session. In some aspects, the network node 710 may allocate the resources to the application session according to channel conditions (for example, according to a CQI or information indicated in a CSI report transmitted by the UE 720 or measurements of an SRS transmitted by the UE 720) in combination with the application capability information that the UE 720 reported for the one or more applications 724. Accordingly, in some aspects, the network node 710 may allocate dedicated network resources (for example, network slices, bandwidth, time domain resources, or other suitable resources) to the UE 720 in accordance with the application capability information reported by the UE 720, or the application capability information reported by the UE 720 in combination with channel conditions associated with the UE 720. Additionally, or alternatively, the network node 710 may assign the UE 720 to a group of UEs 720 that have similar application capabilities and share dedicated network slices or other resource allocations.

FIG. 8 illustrates an example 800 associated with a session management phase for multi-user content diversity. As shown in FIG. 8, example 800 includes communication between a network node 810, a UE 820 that includes a processing system 822 and one or more application clients 824, and an application server 830. In some aspects, the network node 810 may correspond to a network node 110 shown in FIG. 1 (for example, a RAN node, such as a CU, a DU, or an RU), an AP 202 shown in FIG. 2, or a core network device shown in FIG. 3. The UE 820 may correspond to a UE 120 shown in FIG. 1 or an STA 204 shown in FIG. 2, and the processing system 822 may correspond to the processing system 140 shown in FIG. 1. The application server 830 may correspond to the application server 170 shown in FIG. 1, the application server 212 shown in FIG. 2, or the application server 365 shown in FIG. 3. In some aspects, the network node 810 and the UE 820 may communicate in a wireless network, such as wireless communication network 100 or wireless communication network 200, or wireless communication system 300.

As shown in FIG. 8, in a first operation 840, the UE 820 may exchange uplink or downlink traffic that includes content associated with one or more application clients 824 with the network node 810. For example, for downlink (network-generated) traffic, the network node 810 may receive the downlink traffic from the application server 830, and the UE 820 may receive the downlink traffic from the network node 810 via an RF component or modem of the processing system 822. For uplink (user-generated) traffic, the UE 820 may transmit the uplink traffic to the network node 810 via the RF component or modem of the processing system 822, and the network node 810 may send the uplink traffic to the application server 830.

In some aspects, in a second operation 850, the application client 824 may indicate an estimated content quality to the processing system 822. For example, the application client 824 consuming the downlink traffic or generating the uplink traffic may estimate the content quality for a current session. For example, the application client 824 may estimate the content quality according to information received from the application server 830 that indicates one or more content quality metrics, according to a configuration provided by the network node 810 or the application server 830, by measuring or otherwise evaluating content quality metrics according to uplink or downlink traffic measurements, or according to outputs from a media codec or other suitable output that indicates the estimated content quality. Furthermore, in some aspects, the estimated content quality may indicate a historical (for example, actual or backward-looking) content quality experienced by the application client 824, a current content quality that the application client 824 expects to experience in accordance with a scheduling configuration, resource allocation, historical content quality, or one or more inferencing or prediction (for example, AI/ML) techniques, or a projected (for example, future or forward-looking) content quality that the application client 824 expects to experience in accordance with a scheduling configuration, resource allocation, historical content quality, or one or more inferencing or prediction (for example, AI/ML) techniques, among other examples.

In some aspects, in a third operation 860, the UE 820 may transmit (for example, via the processing system 822), and the network node 810 may receive, content quality feedback related to one or more content quality metrics, such as a data rate or bit rate, resolution, FPS, PSNR, stalls, jitter, VMAF, latency, video startup time, or buffering ratio, among other examples. In some aspects, the content quality feedback may indicate the estimated content quality, a desired or target content quality, or the estimated and desired content quality for the application client 824. For example, in some aspects, the content quality feedback may include a set of encoded bits that indicate one or more of the estimated content quality or the desired or target content quality. For example, in some aspects, the content quality feedback may include one bit that has a first value to indicate that the estimated content quality satisfies the desired or target content quality (for example, 0=good or satisfactory quality) or a second value to indicate that the estimated content quality fails to satisfy the desired or target content quality (for example, 1=poor or unsatisfactory quality). Alternatively, the content quality feedback may include multiple bits to indicate whether the estimated content quality satisfies the desired or target content quality with more granularity (for example, the content quality satisfies a minimum requirement, but does not satisfy a desired content quality). Additionally, or alternatively, the content quality feedback may include a set of bits (for example, log₂N bits to indicate one of N possible values, such as 4 bits to indicate one of 16 possible values) that indicate the value of the estimated or desired content quality. Additionally, or alternatively, the content quality feedback may include a first set of bits to indicate whether the estimated content quality satisfies the target or desired content quality and a second set of bits to indicate the value of the estimated or desired content quality. In some aspects, the content quality feedback may relate to uplink content quality, downlink content quality, or a combination thereof, may be associated with a duration or validity period, or may be indicated per logical channel or flow, among other examples. In some aspects, the content quality feedback may be indicated in any suitable message, such as an RRC message, a MAC-CE message, an augmented, overloaded, or punctured PUCCH or PUSCH (for example, a message carrying a CQI or buffer status report (BSR)), a NAS message, a WLAN frame (for example, an 802.11 frame), or a SCONE message.

In some aspects, in a fourth operation 870, the network node 810 may adapt scheduling or a resource allocation for the UE 820 according to the content quality feedback. For example, in some aspects, the network node 810 may increase or decrease a bit rate, may schedule transmissions to or by the UE 820 more or less frequently, may increase or decrease an MCS for the UE 820, or otherwise update a scheduling configuration or a resource allocation for the UE 820 according to the content quality feedback. Alternatively, in some aspects, the updated scheduling configuration or updated resource allocation may be unchanged from a previous scheduling configuration or resource allocation (for example, when the estimated content quality satisfies requirements of the application client 824 and there are not excess resources that could be reallocated to other UEs 820 or made available to increase system capacity or reduce congestion without causing the estimated content quality to fail to satisfy the requirements of the application client 824).

In some aspects, as described herein, the network node 810 may receive the content quality feedback from one or more UEs 820, and may use the content quality feedback to prioritize scheduling or resource allocations among the UEs 820. For example, the network node 810 may assign a highest priority to UEs 820 that are reporting poor content quality estimates, a next highest priority to UEs 820 that are reporting satisfactory content quality estimates with low data rates, and a lowest priority to UEs 820 that are reporting satisfactory content quality estimates with high data rates. Additionally, or alternatively, other suitable metrics or criteria may be used to prioritize the scheduling or resource allocations among the UEs 820, or additional levels of priority may be defined to differentiate UEs 820 according to the content quality feedback. Furthermore, in some aspects, the network node 810 may prioritize scheduling or resource allocations among the UEs 820 using only the content quality feedback, or may prioritize scheduling or resource allocations among the UEs 820 using the content quality feedback and other suitable information such as channel qualities. In some aspects, in examples where the network node 810 reallocates resources from the UE 820 to another UE 820 or frees resources allocated to the UE 820 (for example, in accordance with the UE 820 reporting a good content quality estimate), the network node 810 may transmit, and the UE 820 may receive, a notification to reduce a data rate or otherwise modify a configuration of the application client 824. In some aspects, the notification to modify the configuration of the application client 824 may be transmitted in any suitable message, such as an RRC message, a MAC-CE message, an augmented, overloaded, or punctured PDCCH or PDSCH, a NAS message, a WLAN frame (for example, an 802.11 frame), a SCONE message, or one or more explicit congestion notification (ECN) congestion control bits, among other examples. In examples where the network node 810 notifies the UE 820 to modify the configuration of the application client 824, the processing system 822 may communicate the updated configuration to the application client 824 (for example, indicating a link capacity estimate, a data rate recommended by the network node 810, or other suitable configuration information).

In some aspects, the UE 820 may periodically report updated content quality feedback to the network node 810 or update the content quality feedback in an aperiodic manner (for example, responsive to a notification from the network node 810 to modify the configuration of the application client 824), among other examples. In some aspects, the updated content quality feedback may be indicated in any suitable message, such as an RRC message, a MAC-CE message, an augmented, overloaded, or punctured PUCCH or PUSCH (for example, a message carrying a CQI or BSR), a NAS message, a WLAN frame (for example, an 802.11 frame), or a SCONE message, among other examples. Furthermore, the network node 810 may schedule UEs 820 that do not report content quality feedback or do not respond to notifications from the network node 810 according to an admission control policy.

In some aspects, as further shown in FIG. 8, the application client 824 may optionally report the content quality feedback to the application server 830 in a fifth operation 880. For example, the content quality feedback may include similar information that is indicated to the network node 810. Accordingly, in a sixth operation 890, the application server 830 may likewise adapt scheduling for the UE 820 in accordance with the content quality feedback. Additionally, or alternatively, in some aspects, the content quality feedback provided to the application server 830 (and routed via IP packets through the network node 810) may indicate a selected value for one or more content quality metrics, in accordance with a notification from the network node 810 to modify the configuration of the application client 824 (for example, to reflect an increase or decrease to the resource allocation of the UE 820 in accordance with the content quality feedback).

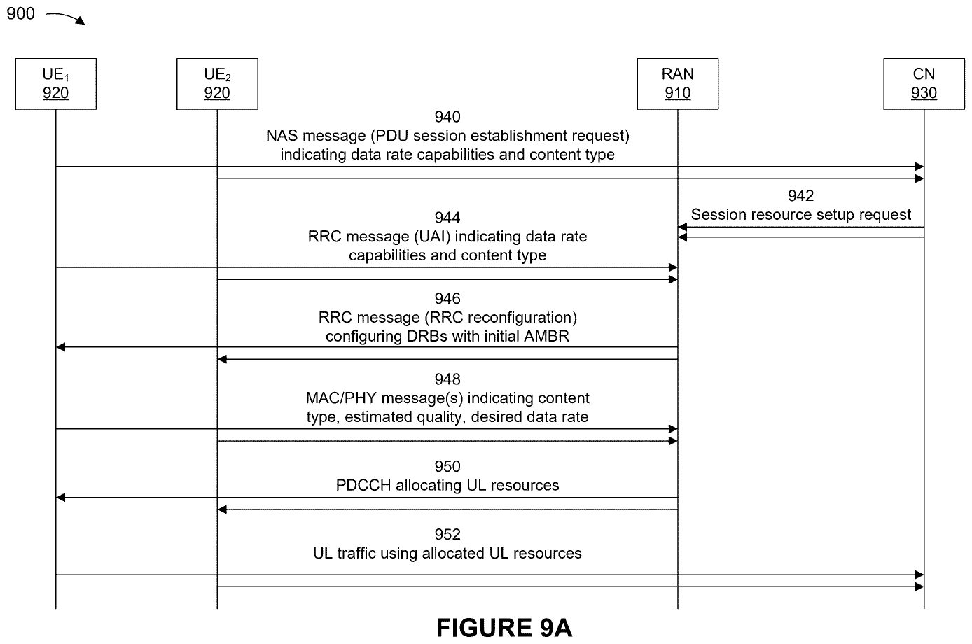

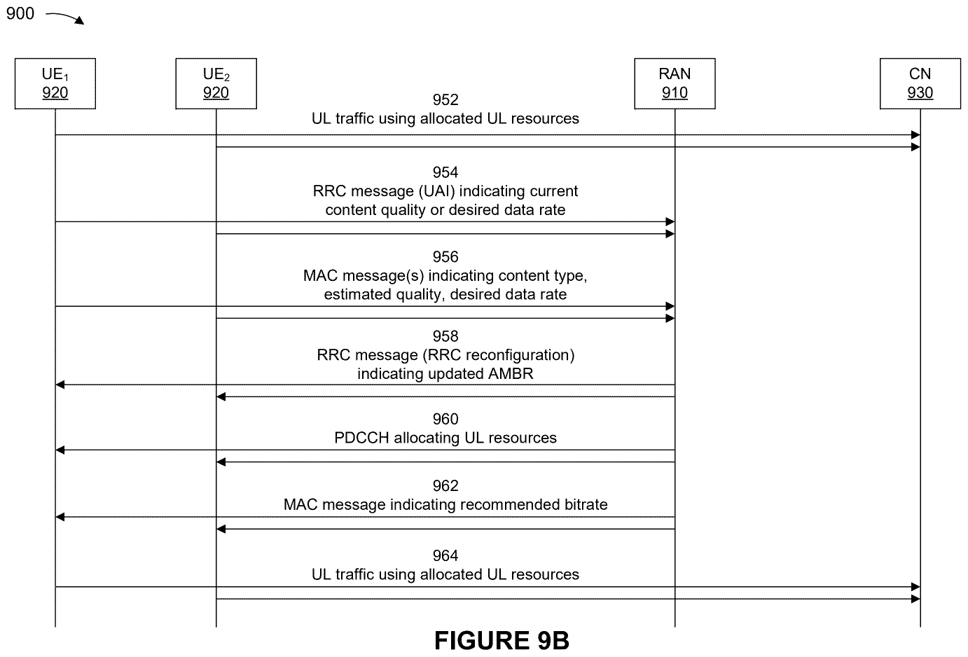

FIGS. 9A-9B illustrate examples 900 associated with signaling for multi-user content diversity. As shown in FIGS. 9A-9B, examples 900 includes communication between a RAN node 910, a first UE 920 (shown as UE₁), a second UE 920 (shown as UE₂), and a core network node 930. In some aspects, the RAN node 910 may correspond to a network node 110 shown in FIG. 1 (for example, a CU, a DU, or an RU). The first UE 920 and the second UE 920 may correspond to a UE 120 shown in FIG. 1. The core network node 930 may correspond to one or more of the core network nodes or devices of the core network 305 shown in FIG. 3. In some aspects, the network node 910, the UEs 920, and the core network node 930 may communicate in a wireless network, such as wireless communication network 100.

More particularly, examples 900 relate to signaling that may be used in a 5G or 6G network to implement multi-user content diversity according to some aspects described herein. Examples 900 are described herein with respect to a scenario where the first UE 920 and the second UE 920 are running live-streaming applications with multiple data rate capabilities, and are initially configured to transmit uplink traffic associated with the live-streaming applications using initial data rates that are adjusted during respective sessions associated with the live-streaming applications. However, the signaling described herein is generally applicable to uplink or downlink traffic, and to content qualities reflected in or impacted by any suitable content quality metric.

For example, as described herein, the first UE 920 may be running a live-streaming application with highly dynamic content (for example, sports or gaming), with an initial uplink data rate of 3.8 Mbps (for example, to support streaming video at a 1080 p resolution, 60 FPS, and using an H.264 codec), which provides poor content quality. Accordingly, to achieve good quality, the first UE 920 may communicate with the network node 910 to request a desired uplink data rate of 5 Mbps (for example, to support streaming video at a 1080 p resolution, 90 FPS, and using the H.264 codec). In addition, the second UE 920 may be running a live-streaming application with relatively static content (for example, a lecture or presentation), with an initial uplink data rate of 3.8 Mbps (for example, to support streaming video at a 1080 p resolution, 60 FPS, and using an H.264 codec), which provides good content quality and exceeds a data rate needed to provide good quality. Accordingly, to maintain the good quality, the second UE 920 may communicate with the network node 910 to request a desired (lower) uplink data rate of 1.5 Mbps (for example, to support streaming video at a 720 p resolution, 30 FPS, and using the H.264 codec). For example, the second UE 920 may request the lower data rate to reduce power consumption, extend battery life, proactively avoid congestion and buffer, or ensure a stable experience in a high-load network.

As shown in FIG. 9A, in a first operation 940, the first UE 920 and the second 920 may each transmit a NAS message to the core network node 930 to request a QoS flow and indicate data rate capabilities and content types for the applications running at the first UE 920 and the second UE 920. For example, the NAS message may include a PDU session establishment request that indicates requested QoS rules (for example, the first UE 920 and the second UE 920 may each request QoS flows with certain QoS identifiers, non-guaranteed bit rate (non-GBR), and a priority of 60), data rate capabilities (for example, the first UE 920 and the second UE 920 may each indicate support for data rates of 1.5 Mbps, 3.8 Mbps, and 5 Mbps), and a content type (for example, the first UE 920 may indicate “dynamic content” and the second UE 920 may indicate “low motion content”). In addition, the NAS message may include an application identifier, such as an identifier for a live-streaming application, that the core network node 930 maps to a QoS identifier. As further shown in FIG. 9A, in a second operation 942, the core network node 930 may process the PDU session establishment requests, and transmit an NG-AP PDU session resource setup request message to the network node 910 in accordance with the information indicated in the PDU session establishment requests received from the first UE 920 and the second UE 920.

As further shown in FIG. 9A, in a third operation 944, the first UE 920 and the second 920 may each transmit an RRC message, such as UE assistance information (UAI), a QoE measurement report, or another suitable message indicating data rate capabilities and a content type. For example, in some aspects, the first UE 920 may support for data rates of 1.5 Mbps, 3.8 Mbps, and 5 Mbps, and indicate a “dynamic content” type, and the second UE 920 may support for data rates of 1.5 Mbps, 3.8 Mbps, and 5 Mbps, and indicate a “low motion content” type. As further shown in FIG. 9A, in a fourth operation 946, the network node 910 may transmit, to each of the first UE 920 and the second UE 920, an RRC message, such as an RRC reconfiguration message, that configures respective data radio bearers (DRBs) (for example, a first QoS flow identifier (QFI) for the first UE 920 and a second QFI for the second UE 920). In addition, the RRC reconfiguration message may indicate an initial aggregate maximum bit rate (AMBR), such as 3.8 Mbps for both UEs 920.

As further shown in FIG. 9A, in a fifth operation 948, the first UE 920 and the second 920 may each transmit one or more MAC layer messages or PHY layer messages to the network node 910 to indicate respective content types, estimated content qualities, and desired data rates. For example, in some aspects, the first UE 920 and the second 920 may transmit respective scheduling requests to request uplink resources for transmitting BSRs that report uplink buffer sizes, such as 3.8 Mbps. In some aspects, the first UE 920 and the second UE 920 may optionally also transmit respective CSI reports to provide channel quality information (for example, the first UE 920 may report a first CQI, such as CQI12, and the second UE 920 may report a second CQI, such as CQI10). In some aspects, the BSRs may be overloaded, augmented, or punctured to carry the estimated content qualities, desired data rates, and content types. For example, the first UE 920 may transmit a BSR that indicates poor content quality and a desired bit rate of 5 Mbps. Additionally or alternatively, the content qualities, desired data rates, and content types may be indicated in dedicated MAC-CEs.

For example, in some aspects, the dedicated MAC-CE may include a logical channel identifier (LCID) field (for example, six bits indicating a logical channel), a direction field (for example, one bit indicating uplink or downlink), a content type indicator (for example, two bits with a first value to indicate static or low motion content, a second value to indicate moderately dynamic content, a third value to indicate highly dynamic content, or a fourth value to indicate another type of content), a content quality indicator field (for example, two bits with a first value to indicate poor quality, a second value to indicate acceptable quality, a third value to indicate very good quality, or a fourth value to indicate another type of content quality), a desired bit rate field to encode a requested bit rate according to configured values (for example, eight bits that may have a value to indicate a desired bit rate of 0.01 Mbps, 0.08 Mbps, 1.2 Mbps, 3.8 Mbps, or 5 Mbps up to 25 Mbps). The MAC-CE may have a total size of 2 bytes, or sixteen bits, and the LCID field may have a value to indicate a content quality LCID. In some aspects, in the case of the first UE 920, the MAC-CE may indicate dynamic content, poor content quality, and a desired bit rate of 5 Mbps.

In this way, the dedicated MAC-CE may provide Layer 2 signaling to complement existing mechanisms (for example, UAI or a QoE measurement report via RRC signaling or a BSR MAC-CE) with a content type, estimated content quality, and a desired bit rates. In some aspects, transmission of the dedicated MAC-CE may be integrated into a MAC protocol. For example, transmission of the dedicated MAC-CE may be triggered when a UE 920 detects a change in content quality or desires a new (for example, higher or lower) bit rate. In some aspects, transmission of the dedicated MAC-CE may triggered by one or more conditions that are configured by RRC signaling (for example, periodic or event-driven transmission when content quality changes). In some aspects, the dedicated MAC-CE may be multiplexed into a MAC PDU along with other user plane data or MAC-CEs, such as a BSR MAC-CE, and may have a higher priority than a BSR MAC-CE and a lower priority than a timing advance command to ensure timely delivery and ensure coexistence with control signaling.

As further shown in FIG. 9A, in a sixth operation 950, the network node 910 may transmit, to each of the first UE 920 and the second UE 920, a DCI message on a PDCCH to allocate uplink PUSCH resource blocks for each UE 920. For example, the network node 910 may allocate uplink PUSCH resource blocks for a 3.8 Mbps bit rate, confirming the session setup. As further shown in FIG. 9A and FIG. 9B, in a seventh operation 952, the first UE 920 and the second UE 920 may then communicate uplink traffic for the live-streaming application using the allocated resources.

As further shown in FIG. 9B, in a eighth operation 954, the first UE 920 and the second 920 may each transmit an RRC message (for example, UAI or a QoE measurement report) to indicate content quality feedback during the live-streaming application sessions. For example, as noted above, the first UE 920 may be experiencing poor content quality, and needs to increase a bit rate from 3.8 Mbps to 5 Mbps, and the second UE 920 may be experiencing good content quality, but can reduce a bit rate from 3.8 Mbps to 1.5 Mbps and still maintain good quality. Accordingly, in the UAI, QoE measurement report, or other RRC message transmitted to the network node 910, the first UE 920 may request an uplink AMBR of 5 Mbps or indicate that the current content quality is poor, and the second UE 920 may request an uplink AMBR of 1.5 Mbps or indicate that the current content quality is good. In some aspects, the network node 910 may receive the UAI, QoE measurement report, or other RRC message and evaluate the request uplink AMBRs and current content qualities against network conditions (for example, a network load, UE channel conditions, or QoS requirements of all UEs 920 in the network) and update a scheduling algorithm as appropriate.

As further shown in FIG. 9B, in a ninth operation 956, the first UE 920 and the second 920 may each transmit MAC layer messages to indicate updated buffer status information to the network node 910. For example, the first UE 920 and the second 920 may each transmit scheduling requests on a PUCCH to request uplink resources for a BSR transmission. The first UE 920 may then use the uplink resources to transmit a BSR indicating an increased buffer size (for example, to support a 5 Mbps bit rate), and the second UE 920 may use the uplink resources to transmit a BSR indicating a decreased buffer size (for example, to support a 3 Mbps bit rate). In some aspects, the BSR may be overloaded, augmented, or punctured to carry the current quality, content type, and desired data rate information (for example, the first UE 920 may indicate a poor content quality and a desired bit rate of 5 Mbps). Additionally, or alternatively, the dedicated MAC-CE described above may be used to carry the information related to content type, estimated content quality, and desired data rate. In some aspects, the network node 910 may then confirm the data rates changes via the BSR or dedicated MAC-CE aligning with the UAI, QoE measurement report, or other information provided in the preceding RRC message. The network node 910 may evaluate the requested changes against network conditions (for example, a network load, UE channel conditions, or QoS requirements of all UEs 920 in the network) and update the scheduler algorithm as appropriate and allocate uplink resources to support the desired data rates for the UEs 920.

As further shown in FIG. 9A, in a tenth operation 958, the network node 910 may transmit, to each of the first UE 920 and the second 920, an RRC message, such as an RRC reconfiguration message, that updates the AMBRs for each UE 920. For example, the RRC message may indicate an AMBR of 5 Mbps for the first UE 920 and an AMBR of 1.5 Mbps for the second UE 920. As further shown in FIG. 9B, in an eleventh operation 960, the network node 910 may transmit DCI messages to the first UE 920 and the second UE 920 on a PDCCH to provide uplink grants that reflect the new resource assignments for 5 Mbps for the first UE 920 and 1.5 Mbps for the second UE 920. As further shown in FIG. 9B, in a twelfth operation 962, the network node 910 may transmit, to each of the first UE 920 and the second UE 920, MAC-CE messages to indicate recommended bit rates (for example, recommending that the first UE 920 update a data rate to 5 Mbps and that the second UE 920 update a data rate to 1.5 Mbps). As further shown in FIG. 9B, in a thirteenth operation 964, the first UE 920 and the second UE 920 may then communicate uplink traffic associated with the live-streaming application according to the recommended bit rate(s). Furthermore, in cases where either UE 920 desires a higher data rate (better content quality) or a lower data rate (reduced and sufficient content quality), the UE(s) 920 and the network node 910 may communicate in a similar manner as described herein to provide content quality feedback and dynamically adjust the resource allocations for the respective live-streaming application session(s).

FIG. 10 is a flowchart illustrating an example process 1000 performed, for example, at a UE or an apparatus of a UE that supports reporting application capabilities or content quality feedback. Example process 1000 is an example where the apparatus or the UE (for example, UE 120 or STA 204) performs operations associated with multi-user content diversity.

As shown in FIG. 10, in some aspects, process 1000 may include communicating with a network node in accordance with a scheduling configuration, wherein communicating with the network node includes one or more of transmitting or receiving traffic related to content for one or more applications (block 1010). For example, the UE (such as by using communication manager 1406, reception component 1402, or transmission component 1404, depicted in FIG. 14) may communicate with a network node in accordance with a scheduling configuration, wherein communicating with the network node includes one or more of transmitting or receiving traffic related to content for one or more applications, as described above.

As further shown in FIG. 10, in some aspects, process 1000 may include transmitting, to the network node, content quality feedback indicating one or more of an estimated content quality or a target content quality related to at least one quality metric for the one or more applications (block 1020). For example, the UE (such as by using communication manager 1406 or transmission component 1404, depicted in FIG. 14) may transmit, to the network node, content quality feedback indicating one or more of an estimated content quality or a target content quality related to at least one quality metric for the one or more applications, as described above.

Process 1000 may include additional aspects, such as any single aspect or any combination of aspects described below or in connection with one or more other processes described elsewhere herein.

In a first additional aspect, process 1000 includes transmitting, to the network node, application capability information that indicates a set of supported values for the at least one content quality metric.

In a second additional aspect, alone or in combination with the first aspect, process 1000 includes receiving, from the network node, information indicating the scheduling configuration in accordance with the application capability information.

In a third additional aspect, alone or in combination with one or more of the first and second aspects, process 1000 includes transmitting, to an application server, information indicated a selected value, of the set of supported values for the at least one content quality metric, in accordance with the information indicating the scheduling configuration or the traffic related to content for one or more applications.

In a fourth additional aspect, alone or in combination with one or more of the first through third aspects, process 1000 includes transmitting, to the network node, updated application capability information that updates the set of supported values for the at least one content quality metric.

In a fifth additional aspect, alone or in combination with one or more of the first through fourth aspects, the application capability information is indicated in an RRC message, a MAC-CE message, a NAS message, a WLAN frame, or a SCONE message.

In a sixth additional aspect, alone or in combination with one or more of the first through fifth aspects, the content quality feedback is associated with a time period during which the content quality feedback is valid.

In a seventh additional aspect, alone or in combination with one or more of the first through sixth aspects, the content quality feedback includes a set of encoded bits indicating one or more of the estimated content quality or the target content quality for the one or more applications.

In an eighth additional aspect, alone or in combination with one or more of the first through seventh aspects, the set of encoded bits includes a single bit that indicates whether the estimated content quality satisfies the target content quality for the one or more applications.

In a ninth additional aspect, alone or in combination with one or more of the first through eighth aspects, the set of encoded bits includes a plurality of bits that indicate one or more of the estimated content quality or the target content quality according to a value for the at least one content quality metric.

In a tenth additional aspect, alone or in combination with one or more of the first through ninth aspects, the set of encoded bits includes a single bit that indicates whether the estimated content quality satisfies the target content quality for the one or more applications and a plurality of bits that indicate one or more of the estimated content quality or the target content quality according to a value for the at least one content quality metric.

In an eleventh additional aspect, alone or in combination with one or more of the first through tenth aspects, the content quality feedback relates to one or more of uplink traffic or downlink traffic for the one or more applications.

In a twelfth additional aspect, alone or in combination with one or more of the first through eleventh aspects, the content quality feedback indicates one or more of the estimated content quality or the target content quality for one or more flows or logical channels carrying the traffic related to the content for the one or more applications.

In a thirteenth additional aspect, alone or in combination with one or more of the first through twelfth aspects, the content quality feedback is indicated in an RRC message, a MAC-CE message, a NAS message, a WLAN frame, or a SCONE message.

In a fourteenth additional aspect, alone or in combination with one or more of the first through thirteenth aspects, a message indicating one or more of a CQI or a BSR is augmented, overloaded, or punctured to indicate the content quality feedback.

In a fifteenth additional aspect, alone or in combination with one or more of the first through fourteenth aspects, process 1000 includes receiving, from the network node, information updating the scheduling configuration in accordance with the content quality feedback.

In a sixteenth additional aspect, alone or in combination with one or more of the first through fifteenth aspects, the information updating the scheduling configuration indicates a decrease to one or more of a resource allocation or the at least one content quality metric in accordance with the content quality feedback indicating that the estimated content quality satisfies the target content quality for the one or more applications.

In a seventeenth additional aspect, alone or in combination with one or more of the first through sixteenth aspects, the information updating the scheduling configuration indicates an increase to one or more of a resource allocation or the at least one content quality metric in accordance with the content quality feedback indicating that the estimated content quality fails to satisfy the target content quality for the one or more applications.

In an eighteenth additional aspect, alone or in combination with one or more of the first through seventeenth aspects, process 1000 includes configuring the one or more applications in accordance with the information updating the scheduling information.

In a nineteenth additional aspect, alone or in combination with one or more of the first through eighteenth aspects, process 1000 includes transmitting, to the network node, channel quality feedback indicating one or more parameters related to a wireless channel, wherein the information updating the scheduling configuration is in accordance with the content quality feedback and the channel quality feedback.

In a twentieth additional aspect, alone or in combination with one or more of the first through nineteenth aspects, the information updating the scheduling configuration is indicated in an RRC message, a MAC-CE message, a DCI message, a NAS message, a WLAN frame, one or more ECN congestion control bits, or a SCONE message.

In a twenty-first additional aspect, alone or in combination with one or more of the first through twentieth aspects, the network node includes one or more of a RAN node, a core network node, a WLAN AP, or an application server in communication with one or more of a RAN node, a core network node, or a WLAN AP.

In a twenty-second additional aspect, alone or in combination with one or more of the first through twenty-first aspects, one or more of the estimated content quality or the target content quality is related to a bit rate or a data rate for the traffic related to the content for the one or more applications.

In a twenty-third additional aspect, alone or in combination with one or more of the first through twenty-second aspects, process 1000 includes transmitting, to the network node, a request to establish a session for transmitting or receiving the traffic related to content for one or more applications, wherein the request is included in a NAS message or an RRC message that indicates a content type and application capability information for the at least one content quality metric.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a flowchart illustrating an example process 1100 performed, for example, at a network node or an apparatus of a network node that supports prioritizing traffic according to UE-reported application capabilities or content quality feedback. Example process 1100 is an example where the apparatus or the network node (for example, network node 110 or AP 202) performs operations associated with multi-user content diversity.

As shown in FIG. 11, in some aspects, process 1100 may include communicating with a UE in accordance with a scheduling configuration, wherein communicating with the UE includes one or more of transmitting or receiving traffic related to content for one or more applications (block 1110). For example, the network node (such as by using communication manager 1506, reception component 1502, or transmission component 1504, depicted in FIG. 15) may communicate with a UE in accordance with a scheduling configuration, wherein communicating with the UE includes one or more of transmitting or receiving traffic related to content for one or more applications, as described above.

As further shown in FIG. 11, in some aspects, process 1100 may include receiving, from the UE, content quality feedback indicating one or more of an estimated content quality or a target content quality related to at least one quality metric for the one or more applications (block 1120). For example, the network node (such as by using communication manager 1506 or reception component 1502, depicted in FIG. 15) may receive, from the UE, content quality feedback indicating one or more of an estimated content quality or a target content quality related to at least one quality metric for the one or more applications, as described above.

As further shown in FIG. 11, in some aspects, process 1100 may include updating the scheduling configuration in accordance with the content quality feedback (block 1130). For example, the network node (such as by using communication manager 1506 or scheduling component 1510, depicted in FIG. 15) may update the scheduling configuration in accordance with the content quality feedback, as described above.

Process 1100 may include additional aspects, such as any single aspect or any combination of aspects described below or in connection with one or more other processes described elsewhere herein.

In a first additional aspect, process 1100 includes receiving, from the UE, application capability information that indicates a set of supported values for the at least one content quality metric.

In a second additional aspect, alone or in combination with the first aspect, process 1100 includes transmitting, to the UE, information indicating the scheduling configuration in accordance with the application capability information.

In a third additional aspect, alone or in combination with one or more of the first and second aspects, process 1100 includes receiving, from the UE, updated application capability information that updates the set of supported values for the at least one content quality metric.

In a fourth additional aspect, alone or in combination with one or more of the first through third aspects, the application capability information is indicated in an RRC message, a MAC-CE message, a NAS message, a WLAN frame, or a SCONE message.

In a fifth additional aspect, alone or in combination with one or more of the first through fourth aspects, the content quality feedback is associated with a time period during which the content quality feedback is valid.

In a sixth additional aspect, alone or in combination with one or more of the first through fifth aspects, the content quality feedback includes a set of encoded bits indicating one or more of the estimated content quality or the target content quality for the one or more applications.

In a seventh additional aspect, alone or in combination with one or more of the first through sixth aspects, the set of encoded bits includes a single bit that indicates whether the estimated content quality satisfies the target content quality for the one or more applications.

In an eighth additional aspect, alone or in combination with one or more of the first through seventh aspects, the set of encoded bits includes a plurality of bits that indicate one or more of the estimated content quality or the target content quality according to a value for the at least one content quality metric.

In a ninth additional aspect, alone or in combination with one or more of the first through eighth aspects, the set of encoded bits includes a single bit that indicates whether the estimated content quality satisfies the target content quality for the one or more applications and a plurality of bits that indicate one or more of the estimated content quality or the target content quality according to a value for the at least one content quality metric.

In a tenth additional aspect, alone or in combination with one or more of the first through ninth aspects, the content quality feedback relates to one or more of uplink traffic or downlink traffic for the one or more applications.

In an eleventh additional aspect, alone or in combination with one or more of the first through tenth aspects, the content quality feedback indicates one or more of the estimated content quality or the target content quality for one or more flows or logical channels carrying the traffic related to the content for the one or more applications.

In a twelfth additional aspect, alone or in combination with one or more of the first through eleventh aspects, the content quality feedback is indicated in an RRC message, a MAC-CE message, a NAS message, a WLAN frame, or a SCONE message.

In a thirteenth additional aspect, alone or in combination with one or more of the first through twelfth aspects, a message indicating one or more of a CQI or a BSR is augmented, overloaded, or punctured to indicate the content quality feedback.

In a fourteenth additional aspect, alone or in combination with one or more of the first through thirteenth aspects, process 1100 includes transmitting, to the UE, information related to updating the scheduling configuration.

In a fifteenth additional aspect, alone or in combination with one or more of the first through fourteenth aspects, the information updating the scheduling configuration indicates a decrease to one or more of a resource allocation or the at least one content quality metric in accordance with the content quality feedback indicating that the estimated content quality satisfies the target content quality for the one or more applications.

In a sixteenth additional aspect, alone or in combination with one or more of the first through fifteenth aspects, the information updating the scheduling configuration indicates an increase to one or more of a resource allocation or the at least one content quality metric in accordance with the content quality feedback indicating that the estimated content quality fails to satisfy the target content quality for the one or more applications.

In a seventeenth additional aspect, alone or in combination with one or more of the first through sixteenth aspects, process 1100 includes receiving, from the UE, channel quality feedback indicating one or more parameters related to a wireless channel, wherein the information updating the scheduling configuration is in accordance with the content quality feedback and the channel quality feedback.

In an eighteenth additional aspect, alone or in combination with one or more of the first through seventeenth aspects, the information updating the scheduling configuration is indicated in an RRC message, a MAC-CE message, a DCI message, a NAS message, a WLAN frame, one or more ECN congestion control bits, or a SCONE message.

In a nineteenth additional aspect, alone or in combination with one or more of the first through eighteenth aspects, the network node includes one or more of a RAN node, a core network node, a WLAN AP, or an application server in communication with one or more of a RAN node, a core network node, or a WLAN AP.

In a twentieth additional aspect, alone or in combination with one or more of the first through nineteenth aspects, one or more of the estimated content quality or the target content quality is related to a bit rate or a data rate for the traffic related to the content for the one or more applications.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a flowchart illustrating an example process 1200 performed, for example, at a network node or an apparatus of a network node that supports prioritizing traffic according to UE-reported application capabilities or content quality feedback. Example process 1200 is an example where the apparatus or the network node (for example, network node 110 or AP 202) performs operations associated with multi-user content diversity.

As shown in FIG. 12, in some aspects, process 1200 may include receiving, from a plurality of UEs, content quality feedback indicating one or more of estimated content qualities or target content qualities related to at least one quality metric for the plurality of UEs (block 1210). For example, the network node (such as by using communication manager 1506 or reception component 1502, depicted in FIG. 15) may receive, from a plurality of UEs, content quality feedback indicating one or more of estimated content qualities or target content qualities related to at least one quality metric for the plurality of UEs, as described above.

As further shown in FIG. 12, in some aspects, process 1200 may include allocating resources for the plurality of UEs in accordance with the content quality feedback received from the plurality of UEs (block 1220). For example, the network node (such as by using communication manager 1506 or scheduling component 1510, depicted in FIG. 15) may allocating resources for the plurality of UEs in accordance with the content quality feedback received from the plurality of UEs, as described above.

As further shown in FIG. 12, in some aspects, process 1200 may include transmitting, to each respective UE of the plurality of UEs, information related to the resources allocated to the respective UE (block 1230). For example, the network node (such as by using communication manager 1506 or transmission component 1504, depicted in FIG. 15) may transmit, to each respective UE of the plurality of UEs, information related to the resources allocated to the respective UE, as described above.

Process 1200 may include additional aspects, such as any single aspect or any combination of aspects described below or in connection with one or more other processes described elsewhere herein.

In a first additional aspect, allocating resources for the plurality of UEs includes assigning a higher priority to resource allocations for a first set of UEs, of the plurality of UEs, that report content quality feedback indicating estimated content qualities that fail to satisfy the target content qualities relative to a second set of UEs, of the plurality of UEs, that report content quality feedback indicating estimated content qualities that satisfy the target content qualities.

In a second additional aspect, alone or in combination with the first aspect, allocating resources for the plurality of UEs includes assigning a higher priority to resource allocations for a first set of UEs, of the plurality of UEs, that report content quality feedback indicating content quality metrics that fail to satisfy a threshold relative to a second set of UEs, of the plurality of UEs, that report content quality feedback indicating content quality metrics that satisfy the threshold.

In a third additional aspect, alone or in combination with one or more of the first and second aspects, process 1200 includes receiving, from the plurality of UEs, channel quality feedback indicating one or more parameters related to wireless channels, wherein the resources allocated for the plurality of UEs is in accordance with the content quality feedback and the channel quality feedback.

In a fourth additional aspect, alone or in combination with one or more of the first through third aspects, allocating resources for the plurality of UEs includes allocating dedicated resources for the plurality of UEs in accordance with the plurality of UEs reporting the content quality feedback.

In a fifth additional aspect, alone or in combination with one or more of the first through fourth aspects, process 1200 includes receiving, from one or more UEs of the plurality of UEs, application capability information that indicates a set of supported values for the at least one content quality metric, and allocating dedicated resources for the one or more UEs in accordance with the one or more UEs reporting the application capability information.

In a sixth additional aspect, alone or in combination with one or more of the first through fifth aspects, process 1200 includes receiving, from one or more UEs of the plurality of UEs, application capability information that indicates a set of supported values for the at least one content quality metric, and assigning each UE, of the plurality of UEs, to a respective group in a dedicated network slice or a respective group that shares a resource allocation in accordance with the application capability information.

In a seventh additional aspect, alone or in combination with one or more of the first through sixth aspects, process 1200 includes allocating resources to a UE that failed to report content quality feedback or failed to respond to a notification related to content quality in accordance with an admission control policy.

Although FIG. 12 shows example blocks of process 1200, in some aspects, process 1200 may include additional blocks, fewer blocks, different blocks, or differently arranged blocks than those depicted in FIG. 12. Additionally or alternatively, two or more of the blocks of process 1200 may be performed in parallel.

FIG. 13 is a flowchart illustrating an example process 1300 performed, for example, at an application server or an apparatus of an application server that supports prioritizing traffic according to UE-reported content quality feedback. Example process 1300 is an example where the apparatus or the application server (for example, application server 170, application server 212, or application server 365) performs operations associated with multi-user content diversity.

As shown in FIG. 13, in some aspects, process 1300 may include receiving, from a UE, content quality feedback indicating one or more of an estimated content quality or a target content quality related to at least one quality metric for one or more applications running at the UE (block 1310). For example, the application server (such as by using communication manager 1606 or reception component 1602, depicted in FIG. 16) may receive, from a UE, content quality feedback indicating one or more of an estimated content quality or a target content quality related to at least one quality metric for one or more applications running at the UE, as described above.

As further shown in FIG. 13, in some aspects, process 1300 may include communicating with the UE using a resource allocation for the one or more applications running at the UE in accordance with the content quality feedback received from the UE (block 1320). For example, the application server (such as by using communication manager 1606, reception component 1602, or transmission component 1604, depicted in FIG. 16) may communicate with the UE using a resource allocation for the one or more applications running at the UE in accordance with the content quality feedback received from the UE, as described above.

Process 1300 may include additional aspects, such as any single aspect or any combination of aspects described below or in connection with one or more other processes described elsewhere herein.

Although FIG. 13 shows example blocks of process 1300, in some aspects, process 1300 may include additional blocks, fewer blocks, different blocks, or differently arranged blocks than those depicted in FIG. 13. Additionally or alternatively, two or more of the blocks of process 1300 may be performed in parallel.

FIG. 14 is a diagram of an example apparatus 1400 for wireless communication that supports reporting application capabilities or content quality feedback. The apparatus 1400 may be a UE 120, or a UE 120 may include the apparatus 1400. In some aspects, the apparatus 1400 includes a reception component 1402, a transmission component 1404, and a communication manager 1406, which may be in communication with one another (for example, via one or more buses). As shown, the apparatus 1400 may communicate with another apparatus 1408 (such as a UE 120, a network node 110, or another wireless communication device) using the reception component 1402 and the transmission component 1404. The communication manager 1406 may be included in, or implemented via, a processing system (for example, the processing system 140). In some aspects, the communication manager 1406 is the communication manager 150.

In some aspects, the apparatus 1400 may be configured to or operable to perform one or more operations described herein in connection with FIGS. 4-8. Additionally or alternatively, the apparatus 1400 may be configured to or operable to perform one or more processes described herein, such as process 1000 of FIG. 10.

The reception component 1402 may receive communications, such as reference signals, control information, or data communications, from the apparatus 1408. The reception component 1402 may provide received communications to one or more other components of the apparatus 1400, such as the communication manager 1406. In some aspects, the reception component 1402 may perform signal processing on the received communications, and may provide the processed signals to the one or more other components in a similar manner as described above in connection with FIG. 1. In some aspects, the reception component 1402 may include one or more components of the UE 120 described above in connection with FIG. 1 or the STA 204 described above in connection with FIG. 2, such as a radio, one or more RF chains, one or more transceivers, or one or more modems, each of which may in turn be coupled with one or more antennas of the UE 120 or the STA 204.

The transmission component 1404 may transmit communications, such as reference signals, control information, or data communications, to the apparatus 1408. In some aspects, the communication manager 1406 may generate communications and may transmit the generated communications to the transmission component 1404 for transmission to the apparatus 1408. In some aspects, the transmission component 1404 may perform signal processing on the generated communications, and may transmit the processed signals to the apparatus 1408 in a similar manner as described above in connection with FIG. 1. In some aspects, the transmission component 1404 may include one or more components of the UE 120 described above in connection with FIG. 1 or the STA 204 described above in connection with FIG. 2, such as a radio, one or more RF chains, one or more transceivers, or one or more modems, each of which may in turn be coupled with one or more antennas of the UE 120 or STA 204. In some aspects, the transmission component 1404 may be co-located with the reception component 1402.

The communication manager 1406 may communicate with a network node in accordance with a scheduling configuration, wherein communicating with the network node includes one or more of transmitting or receiving traffic related to content for one or more applications. The communication manager 1406 may transmit or may cause the transmission component 1404 to transmit, to the network node, content quality feedback indicating one or more of an estimated content quality or a target content quality related to at least one quality metric for the one or more applications. In some aspects, the communication manager 1406 may perform one or more operations described elsewhere herein as being performed by one or more components of the communication manager 1406.

In some aspects, the communication manager 1406 includes a set of components, such as a content quality feedback component 1410. Alternatively, the set of components may be separate and distinct from the communication manager 1406. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 1402 or the transmission component 1404 may communicate with a network node in accordance with a scheduling configuration, wherein communicating with the network node includes one or more of transmitting or receiving traffic related to content for one or more applications. The content quality feedback component 1410 may generate content quality feedback indicating one or more of an estimated content quality or a target content quality related to at least one quality metric for the one or more applications. The transmission component 1404 may transmit or may cause the transmission component 1404 to transmit, to the network node, content quality feedback indicating one or more of an estimated content quality or a target content quality related to at least one quality metric for the one or more applications.

The quantity and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally or alternatively, a set of (one or more) components shown in FIG. 14 may perform one or more functions described as being performed by another set of components shown in FIG. 14.

FIG. 15 is a diagram of an example apparatus 1500 for wireless communication that supports prioritizing traffic according to UE-reported application capabilities or content quality feedback. The apparatus 1500 may be a network node 110, or a network node 110 may include the apparatus 1500. In some aspects, the apparatus 1500 includes a reception component 1502, a transmission component 1504, and a communication manager 1506, which may be in communication with one another (for example, via one or more buses). As shown, the apparatus 1500 may communicate with another apparatus 1508 (such as a UE 120, a network node 110, or another wireless communication device) using the reception component 1502 and the transmission component 1504. The communication manager 1506 may be included in, or implemented via, a processing system (for example, the processing system 145). In some aspects, the communication manager 1506 is the communication manager 155.

In some aspects, the apparatus 1500 may be configured to or operable to perform one or more operations described herein in connection with FIGS. 4-8. Additionally or alternatively, the apparatus 1500 may be configured to or operable to perform one or more processes described herein, such as process 1100 of FIG. 11, or process 1200 of FIG. 12.

The reception component 1502 may receive communications, such as reference signals, control information, or data communications, from the apparatus 1508. The reception component 1502 may provide received communications to one or more other components of the apparatus 1500, such as the communication manager 1506. In some aspects, the reception component 1502 may perform signal processing on the received communications, and may provide the processed signals to the one or more other components in a similar manner as described above in connection with FIG. 1. In some aspects, the reception component 1502 may include one or more components of the network node 110 described above in connection with FIG. 1 or the AP 202 described above in connection with FIG. 2, such as a radio, one or more RF chains, one or more transceivers, or one or more modems, each of which may in turn be coupled with one or more antennas of the network node 110 or AP 202.

The transmission component 1504 may transmit communications, such as reference signals, control information, or data communications, to the apparatus 1508. In some aspects, the communication manager 1506 may generate communications and may transmit the generated communications to the transmission component 1504 for transmission to the apparatus 1508. In some aspects, the transmission component 1504 may perform signal processing on the generated communications, and may transmit the processed signals to the apparatus 1508 in a similar manner as described above in connection with FIG. 1. In some aspects, the transmission component 1504 may include one or more components of the network node 110 described above in connection with FIG. 1 or the AP 202 described above in connection with FIG. 2, such as a radio, one or more RF chains, one or more transceivers, or one or more modems, each of which may in turn be coupled with one or more antennas of the network node 110 or AP 202. In some aspects, the transmission component 1504 may be co-located with the reception component 1502.

The communication manager 1506 may communicate with a UE in accordance with a scheduling configuration, wherein communicating with the UE includes one or more of transmitting or receiving traffic related to content for one or more applications. The communication manager 1506 may receive or may cause the reception component 1502 to receive, from the UE, content quality feedback indicating one or more of an estimated content quality or a target content quality related to at least one quality metric for the one or more applications. The communication manager 1506 may update the scheduling configuration in accordance with the content quality feedback. In some aspects, the communication manager 1506 may perform one or more operations described elsewhere herein as being performed by one or more components of the communication manager 1506.

The communication manager 1506 may receive or may cause the reception component 1502 to receive, from a plurality of UEs, content quality feedback indicating one or more of estimated content qualities or target content qualities related to at least one quality metric for the plurality of UEs. The communication manager 1506 may allocate resources for the plurality of UEs in accordance with the content quality feedback received from the plurality of UEs. The communication manager 1506 may transmit or may cause the transmission component 1504 to transmit, to each respective UE of the plurality of UEs, information related to the resources allocated to the respective UE. In some aspects, the communication manager 1506 may perform one or more operations described elsewhere herein as being performed by one or more components of the communication manager 1506.

In some aspects, the communication manager 1506 includes a set of components, such as a scheduling component 1510. Alternatively, the set of components may be separate and distinct from the communication manager 1506. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 1502 or the transmission component 1504 may communicate with a UE in accordance with a scheduling configuration, wherein communicating with the UE includes one or more of transmitting or receiving traffic related to content for one or more applications. The reception component 1502 may receive, from the UE, content quality feedback indicating one or more of an estimated content quality or a target content quality related to at least one quality metric for the one or more applications. The scheduling component 1510 may update the scheduling configuration in accordance with the content quality feedback.

The reception component 1502 may receive, from a plurality of UEs, content quality feedback indicating one or more of estimated content qualities or target content qualities related to at least one quality metric for the plurality of UEs. The scheduling component 1510 may allocate resources for the plurality of UEs in accordance with the content quality feedback received from the plurality of UEs. The transmission component 1504 may transmit, to each respective UE of the plurality of UEs, information related to the resources allocated to the respective UE.

The quantity and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally or alternatively, a set of (one or more) components shown in FIG. 15 may perform one or more functions described as being performed by another set of components shown in FIG. 15.

FIG. 16 is a diagram of an example apparatus 1600 for wireless communication that supports prioritizing traffic according to UE-reported content quality feedback. The apparatus 1600 may be an application server 170, or an application server 170 may include the apparatus 1600. In some aspects, the apparatus 1600 includes a reception component 1602, a transmission component 1604, and a communication manager 1606, which may be in communication with one another (for example, via one or more buses). As shown, the apparatus 1600 may communicate with another apparatus 1608 (such as a UE 120, a network node 110, or another wireless communication device) using the reception component 1602 and the transmission component 1604. The communication manager 1606 may be included in, or implemented via, a processing system (for example, the processing system 175). In some aspects, the communication manager 1606 is the communication manager 185.

In some aspects, the apparatus 1600 may be configured to or operable to perform one or more operations described herein in connection with FIGS. 4-8. Additionally or alternatively, the apparatus 1600 may be configured to or operable to perform one or more processes described herein, such as process 1300 of FIG. 13.

The reception component 1602 may receive communications, such as reference signals, control information, or data communications, from the apparatus 1608. The reception component 1602 may provide received communications to one or more other components of the apparatus 1600, such as the communication manager 1606. In some aspects, the reception component 1602 may perform signal processing on the received communications, and may provide the processed signals to the one or more other components in a similar manner as described above in connection with FIG. 1. In some aspects, the reception component 1602 may include one or more components of the application server 170 described above in connection with FIG. 1, the application server 212 described above in connection with FIG. 2, or the application server 365 described above in connection with FIG. 3, such as a radio, one or more RF chains, one or more transceivers, or one or more modems, each of which may in turn be coupled with one or more antennas of the application server 170, the application server 212, or the application server 365.

The transmission component 1604 may transmit communications, such as reference signals, control information, or data communications, to the apparatus 1608. In some aspects, the communication manager 1606 may generate communications and may transmit the generated communications to the transmission component 1604 for transmission to the apparatus 1608. In some aspects, the transmission component 1604 may perform signal processing on the generated communications, and may transmit the processed signals to the apparatus 1608 in a similar manner as described above in connection with FIG. 1. In some aspects, the transmission component 1604 may include one or more components of the application server 170 described above in connection with FIG. 1, the application server 212 described above in connection with FIG. 2, or the application server 365 described above in connection with FIG. 3, such as a radio, one or more RF chains, one or more transceivers, or one or more modems, each of which may in turn be coupled with one or more antennas of the application server 170, the application server 212, or the application server 365. In some aspects, the transmission component 1604 may be co-located with the reception component 1602.

The communication manager 1606 may receive or may cause the reception component 1602 to receive, from a UE, content quality feedback indicating one or more of an estimated content quality or a target content quality related to at least one quality metric for one or more applications running at the UE. The communication manager 1606 may communicate with the UE using a resource allocation for the one or more applications running at the UE in accordance with the content quality feedback received from the UE. In some aspects, the communication manager 1606 may perform one or more operations described elsewhere herein as being performed by one or more components of the communication manager 1606.

In some aspects, the communication manager 1606 includes a set of components, such as a resource allocation component 1610. Alternatively, the set of components may be separate and distinct from the communication manager 1606. As used herein, the term “component” is intended to be broadly construed as hardware or a combination of hardware and at least one of software or firmware. In some aspects, one or more components of the set of components may include or may be implemented within a processing system (for example, the processing system 175). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 1602 may receive, from a UE, content quality feedback indicating one or more of an estimated content quality or a target content quality related to at least one quality metric for one or more applications running at the UE. The resource allocation component 1610 may determine a resource allocation for the one or more applications running at the UE in accordance with the content quality feedback received from the UE. The reception component 1602 or the transmission component 1604 may communicate with the UE using the resource allocation for the one or more applications running at the UE in accordance with the content quality feedback received from the UE.

The quantity and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally or alternatively, a set of (one or more) components shown in FIG. 16 may perform one or more functions described as being performed by another set of components shown in FIG. 15.

The following provides an overview of some Aspects of the present disclosure:
Aspect 1: A method of wireless communication performed by a UE, comprising: communicating with a network node in accordance with a scheduling configuration, wherein communicating with the network node includes one or more of transmitting or receiving traffic related to content for one or more applications; and transmitting, to the network node, content quality feedback indicating one or more of an estimated content quality or a target content quality related to at least one quality metric for the one or more applications.
Aspect 2: The method of Aspect 1, further comprising: transmitting, to the network node, application capability information that indicates a set of supported values for the at least one content quality metric.
Aspect 3: The method of Aspect 2, further comprising: receiving, from the network node, information indicating the scheduling configuration in accordance with the application capability information.
Aspect 4: The method of Aspect 2, further comprising: transmitting, to an application server, information indicated a selected value, of the set of supported values for the at least one content quality metric, in accordance with the information indicating the scheduling configuration or the traffic related to content for one or more applications.
Aspect 5: The method of Aspect 2, further comprising: transmitting, to the network node, updated application capability information that updates the set of supported values for the at least one content quality metric.
Aspect 6: The method of Aspect 2, wherein the application capability information is indicated in an RRC message, a MAC-CE message, a NAS message, a WLAN frame, or a SCONE message.
Aspect 7: The method of any of Aspects 1-6, wherein the content quality feedback is associated with a time period during which the content quality feedback is valid.
Aspect 8: The method of any of Aspects 1-7, wherein the content quality feedback includes a set of encoded bits indicating one or more of the estimated content quality or the target content quality for the one or more applications.
Aspect 9: The method of Aspect 8, wherein the set of encoded bits includes a single bit that indicates whether the estimated content quality satisfies the target content quality for the one or more applications.
Aspect 10: The method of Aspect 8, wherein the set of encoded bits includes a plurality of bits that indicate one or more of the estimated content quality or the target content quality according to a value for the at least one content quality metric.
Aspect 11: The method of Aspect 8, wherein the set of encoded bits includes a single bit that indicates whether the estimated content quality satisfies the target content quality for the one or more applications and a plurality of bits that indicate one or more of the estimated content quality or the target content quality according to a value for the at least one content quality metric.
Aspect 12: The method of any of Aspects 1-11, wherein the content quality feedback relates to one or more of uplink traffic or downlink traffic for the one or more applications.
Aspect 13: The method of any of Aspects 1-12, wherein the content quality feedback indicates one or more of the estimated content quality or the target content quality for one or more flows or logical channels carrying the traffic related to the content for the one or more applications.
Aspect 14: The method of any of Aspects 1-13, wherein the content quality feedback is indicated in an RRC message, a MAC-CE message, a NAS message, a WLAN frame, or a SCONE message.
Aspect 15: The method of any of Aspects 1-14, wherein a message indicating one or more of a CQI or a BSR is augmented, overloaded, or punctured to indicate the content quality feedback.
Aspect 16: The method of any of Aspects 1-15, further comprising: receiving, from the network node, information updating the scheduling configuration in accordance with the content quality feedback.
Aspect 17: The method of Aspect 16, wherein the information updating the scheduling configuration indicates a decrease to one or more of a resource allocation or the at least one content quality metric in accordance with the content quality feedback indicating that the estimated content quality satisfies the target content quality for the one or more applications.
Aspect 18: The method of Aspect 16, wherein the information updating the scheduling configuration indicates an increase to one or more of a resource allocation or the at least one content quality metric in accordance with the content quality feedback indicating that the estimated content quality fails to satisfy the target content quality for the one or more applications.
Aspect 19: The method of Aspect 16, further comprising: configuring the one or more applications in accordance with the information updating the scheduling information.
Aspect 20: The method of Aspect 16, further comprising: transmitting, to the network node, channel quality feedback indicating one or more parameters related to a wireless channel, wherein the information updating the scheduling configuration is in accordance with the content quality feedback and the channel quality feedback.
Aspect 21: The method of Aspect 16, wherein the information updating the scheduling configuration is indicated in an RRC message, a MAC-CE message, a DCI message, a NAS message, a WLAN frame, one or more ECN congestion control bits, or a SCONE message.
Aspect 22: The method of any of Aspects 1-21, wherein the network node includes one or more of a RAN node, a core network node, a WLAN AP, or an application server in communication with one or more of a RAN node, a core network node, or a WLAN AP.
Aspect 23: The method of any of Aspects 1-22, wherein one or more of the estimated content quality or the target content quality is related to a bit rate or a data rate for the traffic related to the content for the one or more applications.
Aspect 24: The method of any of Aspects 1-23, further comprising: transmitting, to the network node, a request to establish a session for transmitting or receiving the traffic related to content for one or more applications, wherein the request is included in a NAS message or an RRC message that indicates a content type and application capability information for the at least one content quality metric.
Aspect 25: A method of wireless communication performed by a network node, comprising: communicating with a UE in accordance with a scheduling configuration, wherein communicating with the UE includes one or more of transmitting or receiving traffic related to content for one or more applications; receiving, from the UE, content quality feedback indicating one or more of an estimated content quality or a target content quality related to at least one quality metric for the one or more applications; and updating the scheduling configuration in accordance with the content quality feedback.
Aspect 26: The method of Aspect 25, further comprising: receiving, from the UE, application capability information that indicates a set of supported values for the at least one content quality metric.
Aspect 27: The method of Aspect 26, further comprising: transmitting, to the UE, information indicating the scheduling configuration in accordance with the application capability information.
Aspect 28: The method of Aspect 26, further comprising: receiving, from the UE, updated application capability information that updates the set of supported values for the at least one content quality metric.
Aspect 29: The method of Aspect 26, wherein the application capability information is indicated in an RRC message, a MAC-CE message, a NAS message, a WLAN frame, or a SCONE message.
Aspect 30: The method of any of Aspects 25-29, wherein the content quality feedback is associated with a time period during which the content quality feedback is valid.
Aspect 31: The method of any of Aspects 25-30, wherein the content quality feedback includes a set of encoded bits indicating one or more of the estimated content quality or the target content quality for the one or more applications.
Aspect 32: The method of Aspect 31, wherein the set of encoded bits includes a single bit that indicates whether the estimated content quality satisfies the target content quality for the one or more applications.
Aspect 33: The method of Aspect 31, wherein the set of encoded bits includes a plurality of bits that indicate one or more of the estimated content quality or the target content quality according to a value for the at least one content quality metric.
Aspect 34: The method of Aspect 31, wherein the set of encoded bits includes a single bit that indicates whether the estimated content quality satisfies the target content quality for the one or more applications and a plurality of bits that indicate one or more of the estimated content quality or the target content quality according to a value for the at least one content quality metric.
Aspect 35: The method of any of Aspects 25-34, wherein the content quality feedback relates to one or more of uplink traffic or downlink traffic for the one or more applications.
Aspect 36: The method of any of Aspects 25-35, wherein the content quality feedback indicates one or more of the estimated content quality or the target content quality for one or more flows or logical channels carrying the traffic related to the content for the one or more applications.
Aspect 37: The method of any of Aspects 25-36, wherein the content quality feedback is indicated in an RRC message, a MAC-CE message, a NAS message, a WLAN frame, or a SCONE message.
Aspect 38: The method of any of Aspects 25-37, wherein a message indicating one or more of a CQI or a BSR is augmented, overloaded, or punctured to indicate the content quality feedback.
Aspect 39: The method of any of Aspects 25-38, further comprising: transmitting, to the UE, information related to updating the scheduling configuration.
Aspect 40: The method of Aspect 39, wherein the information updating the scheduling configuration indicates a decrease to one or more of a resource allocation or the at least one content quality metric in accordance with the content quality feedback indicating that the estimated content quality satisfies the target content quality for the one or more applications.
Aspect 41: The method of Aspect 39, wherein the information updating the scheduling configuration indicates an increase to one or more of a resource allocation or the at least one content quality metric in accordance with the content quality feedback indicating that the estimated content quality fails to satisfy the target content quality for the one or more applications.
Aspect 42: The method of Aspect 39, further comprising: receiving, from the UE, channel quality feedback indicating one or more parameters related to a wireless channel, wherein the information updating the scheduling configuration is in accordance with the content quality feedback and the channel quality feedback.
Aspect 43: The method of Aspect 39, wherein the information updating the scheduling configuration is indicated in an RRC message, a MAC-CE message, a DCI message, a NAS message, a WLAN frame, one or more ECN congestion control bits, or a SCONE message.
Aspect 44: The method of any of Aspects 25-43, wherein the network node includes one or more of a RAN node, a core network node, a WLAN AP, or an application server in communication with one or more of a RAN node, a core network node, or a WLAN AP.
Aspect 45: The method of any of Aspects 25-44, wherein one or more of the estimated content quality or the target content quality is related to a bit rate or a data rate for the traffic related to the content for the one or more applications.
Aspect 46: A method of wireless communication performed by a network node, comprising: receiving, from a plurality of UEs, content quality feedback indicating one or more of estimated content qualities or target content qualities related to at least one quality metric for the plurality of UEs; allocating resources for the plurality of UEs in accordance with the content quality feedback received from the plurality of UEs; and transmitting, to each respective UE of the plurality of UEs, information related to the resources allocated to the respective UE.
Aspect 47: The method of Aspect 46, wherein allocating resources for the plurality of UEs includes: assigning a higher priority to resource allocations for a first set of UEs, of the plurality of UEs, that report content quality feedback indicating estimated content qualities that fail to satisfy the target content qualities relative to a second set of UEs, of the plurality of UEs, that report content quality feedback indicating estimated content qualities that satisfy the target content qualities.
Aspect 48: The method of any of Aspects 46-47, wherein allocating resources for the plurality of UEs includes: assigning a higher priority to resource allocations for a first set of UEs, of the plurality of UEs, that report content quality feedback indicating content quality metrics that fail to satisfy a threshold relative to a second set of UEs, of the plurality of UEs, that report content quality feedback indicating content quality metrics that satisfy the threshold.
Aspect 49: The method of any of Aspects 46-48, further comprising: receiving, from the plurality of UEs, channel quality feedback indicating one or more parameters related to wireless channels, wherein the resources allocated for the plurality of UEs is in accordance with the content quality feedback and the channel quality feedback.
Aspect 50: The method of any of Aspects 46-49, wherein allocating resources for the plurality of UEs includes: allocating dedicated resources for the plurality of UEs in accordance with the plurality of UEs reporting the content quality feedback.
Aspect 51: The method of any of Aspects 46-50, further comprising: receiving, from one or more UEs of the plurality of UEs, application capability information that indicates a set of supported values for the at least one content quality metric; and allocating dedicated resources for the one or more UEs in accordance with the one or more UEs reporting the application capability information.
Aspect 52: The method of any of Aspects 46-51, further comprising: receiving, from one or more UEs of the plurality of UEs, application capability information that indicates a set of supported values for the at least one content quality metric; and assigning each UE, of the plurality of UEs, to a respective group in a dedicated network slice or a respective group that shares a resource allocation in accordance with the application capability information.
Aspect 53: The method of any of Aspects 46-52, further comprising: allocating resources to a UE that failed to report content quality feedback or failed to respond to a notification related to content quality in accordance with an admission control policy.
Aspect 54: A method of communication performed by an application server, comprising: receiving, from a UE, content quality feedback indicating one or more of an estimated content quality or a target content quality related to at least one quality metric for one or more applications running at the UE; and communicating with the UE using a resource allocation for the one or more applications running at the UE in accordance with the content quality feedback received from the UE.
Aspect 55: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-54.
Aspect 56: An apparatus for wireless communication at a device, the apparatus comprising one or more memories and one or more processors coupled to the one or more memories, the one or more processors configured to cause the device to perform the method of one or more of Aspects 1-54.
Aspect 57: An apparatus for wireless communication, the apparatus comprising at least one means for performing the method of one or more of Aspects 1-54.
Aspect 58: A non-transitory computer-readable medium storing code for wireless communication, the code comprising instructions executable by one or more processors to perform the method of one or more of Aspects 1-54.
Aspect 59: A non-transitory computer-readable medium storing a set of instructions for wireless communication, the set of instructions comprising one or more instructions that, when executed by one or more processors of a device, cause the device to perform the method of one or more of Aspects 1-54.
Aspect 60: A device for wireless communication, the device comprising a processing system that includes one or more processors and one or more memories coupled with the one or more processors, the processing system configured to cause the device to perform the method of one or more of Aspects 1-54.
Aspect 61: An apparatus for wireless communication at a device, the apparatus comprising one or more memories and one or more processors coupled to the one or more memories, the one or more processors individually or collectively configured to cause the device to perform the method of one or more of Aspects 1-54.
Aspect 62: A device comprising a processing system that includes one or more processors and one or more code-storing memories coupled with the one or more processors, the processing system configured to cause the device to perform the method of one or more of Aspects 1-54.
Aspect 63: A device comprising a processing system that includes processor circuitry and code-storing memory circuitry, the processing system configured to cause the device to perform the method of one or more of Aspects 1-54.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a plurality of antennas; and
a processing system that includes one or more processors and one or more code-storing memories coupled with the one or more processors, the processing system configured to cause the UE to:
wirelessly communicate, via the plurality of antennas, with a network node in accordance with a scheduling configuration, wherein communicating with the network node includes one or more of transmitting or receiving traffic related to content for one or more applications; and
wirelessly transmit, to the network node via the plurality of antennas, content quality feedback indicating one or more of an estimated content quality or a target content quality related to at least one quality metric for the one or more applications.

2. The UE of claim 1, wherein the processing system is further configured to cause the UE to:
wirelessly transmit, to the network node via the plurality of antennas, application capability information that indicates a set of supported values for the at least one content quality metric; and
wirelessly receive, from the network node via the plurality of antennas, information indicating the scheduling configuration in accordance with the application capability information.

3. The UE of claim 1, wherein the processing system is further configured to cause the UE to:
wirelessly transmit, to the network node via the plurality of antennas, application capability information that indicates a set of supported values for the at least one content quality metric; and
wirelessly transmit, to an application server via the plurality of antennas, information indicated a selected value, of the set of supported values for the at least one content quality metric, in accordance with the information indicating the scheduling configuration or the traffic related to content for one or more applications.

4. The UE of claim 1, wherein the processing system is further configured to cause the UE to:
wirelessly transmit, to the network node via the plurality of antennas, application capability information that indicates a set of supported values for the at least one content quality metric; and
wirelessly transmit, to the network node via the plurality of antennas, updated application capability information that updates the set of supported values for the at least one content quality metric.

5. The UE of claim 1, wherein the content quality feedback is associated with a time period during which the content quality feedback is valid.

6. The UE of claim 1, wherein the content quality feedback includes a set of encoded bits indicating one or more of the estimated content quality or the target content quality for the one or more applications, wherein the set of encoded bits includes one or more of:
a single bit indicating whether the estimated content quality satisfies the target content quality for the one or more applications, or
a plurality of bits indicating one or more of the estimated content quality or the target content quality according to a value for the at least one content quality metric.

7. The UE of claim 1, wherein the content quality feedback indicates one or more of the estimated content quality or the target content quality for one or more flows or logical channels carrying the traffic related to the content for the one or more applications.

8. The UE of claim 1, wherein the processing system is further configured to cause the UE to:
wirelessly receive, from the network node via the plurality of antennas, information updating the scheduling configuration in accordance with the content quality feedback, wherein the information updating the scheduling configuration indicates one or more of:
a decrease to one or more of a resource allocation or the at least one content quality metric in accordance with the content quality feedback indicating that the estimated content quality satisfies the target content quality for the one or more applications, or
an increase to one or more of a resource allocation or the at least one content quality metric in accordance with the content quality feedback indicating that the estimated content quality fails to satisfy the target content quality for the one or more applications.

9. The UE of claim 1, wherein the processing system is further configured to cause the UE to:
wirelessly transmit, to the network node via the plurality of antennas, channel quality feedback indicating one or more parameters related to a wireless channel; and
wirelessly receive, from the network node via the plurality of antennas, information updating the scheduling configuration, wherein the information updating the scheduling configuration is in accordance with the content quality feedback and the channel quality feedback.

10. The UE of claim 1, wherein one or more of the estimated content quality or the target content quality is related to a bit rate or a data rate for the traffic related to the content for the one or more applications.

11. A network node, comprising:
a plurality of antennas; and
a processing system that includes one or more processors and one or more code-storing memories coupled with the one or more processors, the processing system configured to cause the network node to:
wirelessly communicate, via the plurality of antennas, with a user equipment (UE) in accordance with a scheduling configuration, wherein communicating with the UE includes one or more of transmitting or receiving traffic related to content for one or more applications;
wirelessly receive, from the UE via the plurality of antennas, content quality feedback indicating one or more of an estimated content quality or a target content quality related to at least one quality metric for the one or more applications; and
update the scheduling configuration in accordance with the content quality feedback.

12. The network node of claim 11, wherein the processing system is further configured to cause the network node to:
wirelessly receive, from the UE via the plurality of antennas, application capability information that indicates a set of supported values for the at least one content quality metric.

13. The network node of claim 11, wherein the content quality feedback is associated with a time period during which the content quality feedback is valid.

14. The network node of claim 11, wherein the content quality feedback includes a set of encoded bits indicating one or more of the estimated content quality or the target content quality for the one or more applications, and wherein the set of encoded bits includes one or more of:
a single bit indicating whether the estimated content quality satisfies the target content quality for the one or more applications, or
a plurality of bits indicating one or more of the estimated content quality or the target content quality according to a value for the at least one content quality metric.

15. The network node of claim 11, wherein the content quality feedback indicates one or more of the estimated content quality or the target content quality for one or more flows or logical channels carrying the traffic related to the content for the one or more applications.

16. The network node of claim 11, wherein the processing system is further configured to cause the network node to:
wirelessly transmit, to the UE via the plurality of antennas, information related to updating the scheduling configuration, wherein the information updating the scheduling configuration indicates:
a decrease to one or more of a resource allocation or the at least one content quality metric in accordance with the content quality feedback indicating that the estimated content quality satisfies the target content quality for the one or more applications, or
an increase to one or more of a resource allocation or the at least one content quality metric in accordance with the content quality feedback indicating that the estimated content quality fails to satisfy the target content quality for the one or more applications.

17. The network node of claim 11, wherein the processing system is further configured to cause the network node to:
wirelessly receive, from the UE via the plurality of antennas, channel quality feedback indicating one or more parameters related to a wireless channel; and
wirelessly transmit, to the UE via the plurality of antennas, information related to updating the scheduling configuration, wherein the information updating the scheduling configuration is in accordance with the content quality feedback and the channel quality feedback.

18. The network node of claim 11, wherein one or more of the estimated content quality or the target content quality is related to a bit rate or a data rate for the traffic related to the content for the one or more applications.

19. A network node, comprising:
a plurality of antennas; and
a processing system that includes one or more processors and one or more code-storing memories coupled with the one or more processors, the processing system configured to cause the network node to:
wirelessly receive, from a plurality of user equipments (UEs) via the plurality of antennas, content quality feedback indicating one or more of estimated content qualities or target content qualities related to at least one quality metric for the plurality of UEs;
allocate resources for the plurality of UEs in accordance with the content quality feedback received from the plurality of UEs; and
wirelessly transmit, to each respective UE of the plurality of UEs via the plurality of antennas, information related to the resources allocated to the respective UE.

20. The network node of claim 19, wherein to allocate resources for the plurality of UEs, the processing system is further configured to cause the network node to:
assign a higher priority to resource allocations for a first set of UEs, of the plurality of UEs, that report content quality feedback indicating one or more of:
estimated content qualities that fail to satisfy the target content qualities relative to a second set of UEs, of the plurality of UEs, that report content quality feedback indicating estimated content qualities that satisfy the target content qualities, or
content quality metrics that fail to satisfy a threshold relative to a second set of UEs, of the plurality of UEs, that report content quality feedback indicating content quality metrics that satisfy the threshold.
